(19) United States
(12) Patent Application Publication
(10) Pub. No.: US 2026/0022059 A1
(43) Pub. Date: Jan. 22, 2026

(54) SMELTING AND FIBER SPINNING PROCESS

(71) Applicant: ARMSTRONG WORLD INDUSTRIES, INC., Lancaster, PA (US)

(72) Inventors: Marsha S. BISCHEL, Lancaster, PA (US); Charles G. KRICK, Lititz, PA (US)

(73) Assignee: ARMSTRONG WORLD INDUSTRIES, INC., Lancaster, PA (US)

(21) Appl. No.: 19/275,095

(22) Filed: Jul. 21, 2025

Related U.S. Application Data
(60) Provisional application No. 63/673,778, filed on Jul. 21, 2024.

(51) Int. Cl. C03C 13/06; C03B 5/027; C03B 37/04; C03C 1/00; C03C 3/062; C03C 3/097; C08K 7/14; E04C 2/16

(52) U.S. Cl. CPC C03C 13/06; C03B 5/027; C03B 37/04; C03C 1/002; C03C 3/062; C03C 3/097; C08K 7/14; E04C 2/16

(57) ABSTRACT

Described herein is a method of smelting to form an inorganic fiber, the method comprising: a) introducing a silicomanganese slag and a smelting additive into a furnace, the smelting additive comprising biochar; b) smelting the silicomanganese slag in the presence of the smelting additive into a silicomanganese metal and a smelting byproduct; and c) flowing the smelting byproduct from the furnace from a first outlet to a fiber spinning apparatus; and step d) processing the smelting byproduct by the fiber spinning apparatus to form the inorganic fiber.

### CROSS-REFERENCE TO RELATED APPLICATION

This application is U.S. Non-Provisional Patent application claiming priority to U.S. Provisional Patent Application No. 63/673,778, filed on Jul. 21, 2024, the disclosure of which is incorporated herein by reference in its entirety.

### BACKGROUND

Previously, mineral wool making operations involved melting of slag from steel making, blast furnace operations, or virgin sources—such as basalt. In such cases, residual iron may be melted out of the starting components using a coal-fire cupola to melt slag. However, cupolas are sources of carbon dioxide and sulfates due to their dependence on coal and coke. Therefore, a new approach for creating such fibers is needed.

### BRIEF SUMMARY

In some embodiments, the present invention is directed to a method of smelting to form an inorganic fiber, the method comprising: a) introducing a silicomanganese slag and a smelting additive into a furnace, the smelting additive comprising biochar; b) smelting the silicomanganese slag in the presence of the smelting additive into a silicomanganese metal and a smelting byproduct; and c) flowing the smelting byproduct from the furnace from a first outlet to a fiber spinning apparatus; and step d) processing the smelting byproduct by the fiber spinning apparatus to form the inorganic fiber.

In other embodiments, the present invention includes a building panel comprising a first major exposed surface opposite a second major exposed surface, the building panel comprising a body having an upper surface opposite a lower surface, the body comprising an organic fiber formed by the previously recited process, a binder, and a filler.

Other embodiments of the present invention include a ceiling system comprising at least one of the aforementioned building panels, a plurality of support struts comprising a support flange, and wherein the support struts are configured to support the first major exposed surface of the building panel.

In other embodiments, the present invention is directed to a system for the product of inorganic fiber from silicomanganese slag, the system comprising a power control device; a furnace comprising a chamber; a first outlet in fluid communication with the chamber; a second outlet in fluid communication with the chamber; and at least two electrodes; a fiber spinning apparatus in fluid communication with the first outlet of the collection zone; wherein a silicomanganese metal and a smelting additive comprising biochar are present in the chamber and the power control device is configured to apply power to the silicomanganese metal and biochar through the at least two electrodes; and wherein the fiber spinning apparatus is configured to spin a smelting byproduct formed from the silicomanganese metal and biochar.

Other embodiments of the present invention include an inorganic fiber comprising SiO₂ in an amount ranging from about 35 wt. % to about 50 wt. % based on the total weight of the inorganic fiber; Al₂O₃ in an amount ranging from about 2 wt. % to about 22 wt. % based on the total weight of the inorganic fiber; MnO in an amount ranging from about 1 wt. % to about 7 wt. % based on the total weight of the inorganic fiber; MgO in an amount ranging from about 4 wt. % to about 20 wt. % based on the total weight of the inorganic fiber; and CaO in an amount ranging from about 15 wt. % to about 30 wt. % based on the total weight of the inorganic fiber; and wherein the total amount of SiO₂, Al₂O₃, MnO, MgO, CaO sum to an amount less than 100 wt. % based on the total weight of the inorganic fiber.

Other embodiments of the present invention include a building panel comprising a first major exposed surface opposite a second major exposed surface, the building panel comprising a body having an upper surface opposite a lower surface, the body comprising the aforementioned inorganic fiber; a binder; and a filler.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic representation of a system according to the present invention;

FIG. 2 is a schematic representation of a system according to the present invention;

FIG. 3 is a flow-diagram representing a methodology of the present invention; and

FIG. 4 is a flow-diagram representing a methodology of the present invention

FIG. 5 is a graph of amount of metal recovered relative to amount of carbon;

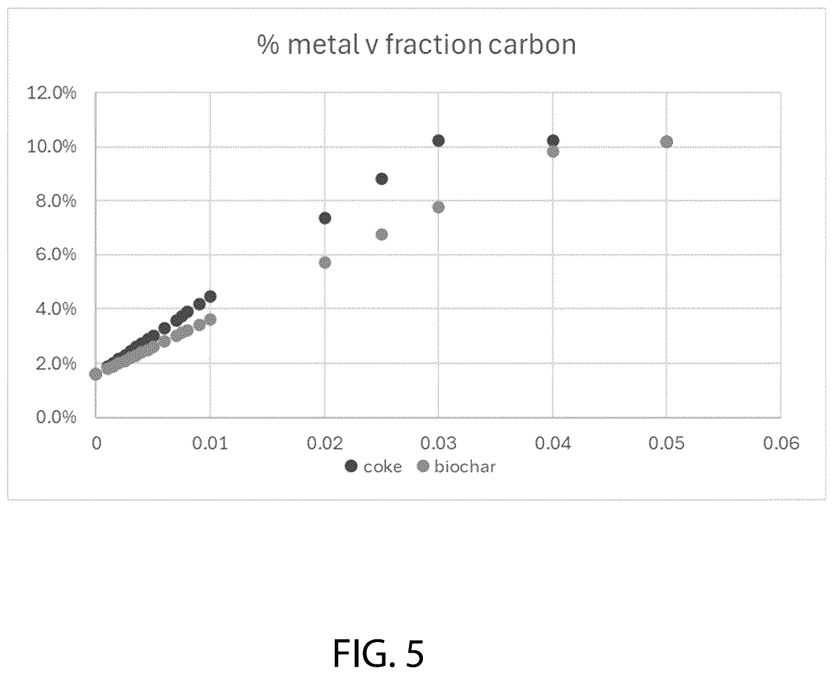

FIG. 6 is a graph of amount of metal recovered relative to amount of carbon;

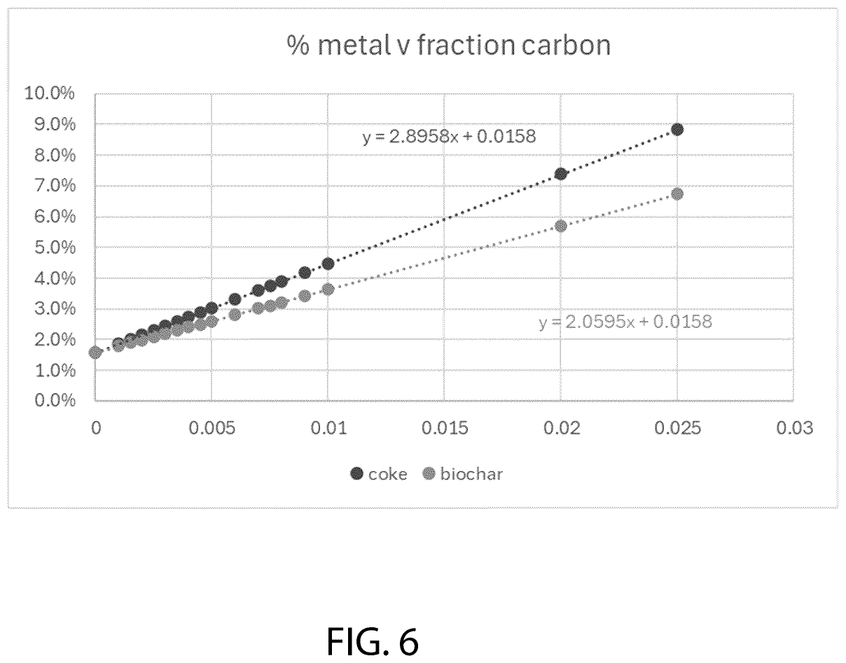

FIG. 7 is a graph of amount of metal recovered relative to amount of carbon;

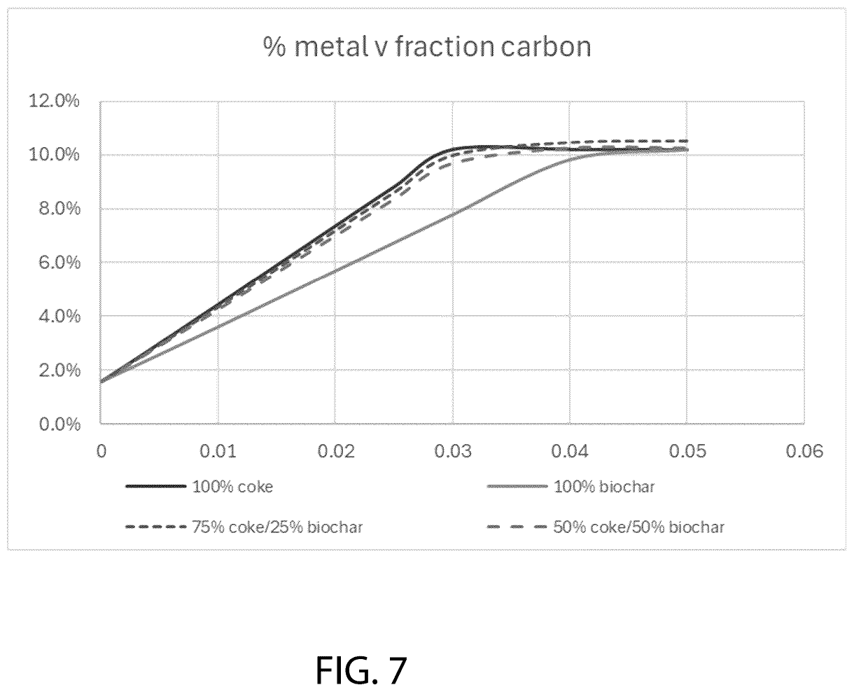

FIG. 8 is a graph of amount of metal recovered relative to amount of carbon;

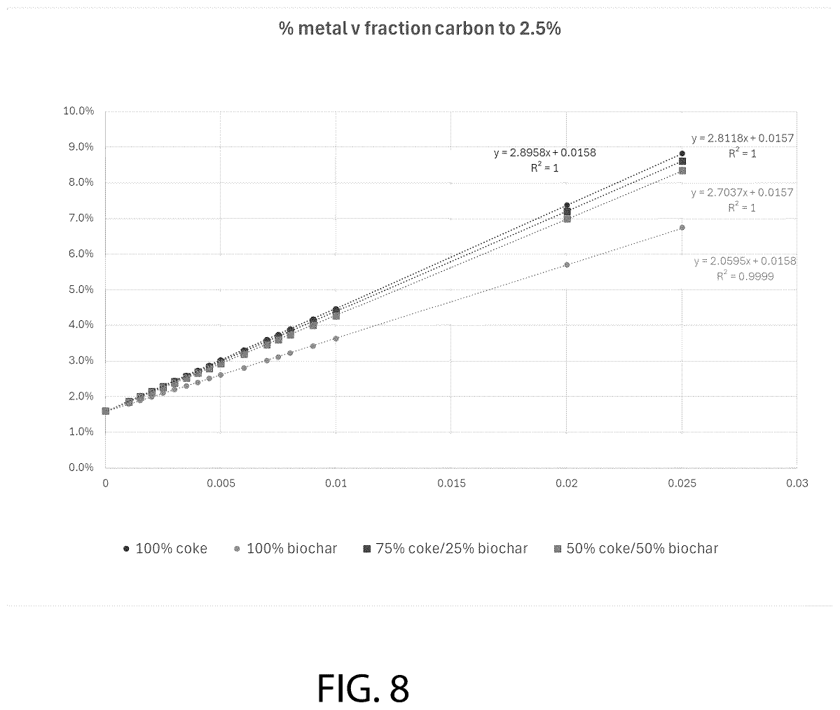

FIG. 9 is a graph of power supplied per ton of wool produced relative to amount of carbon;

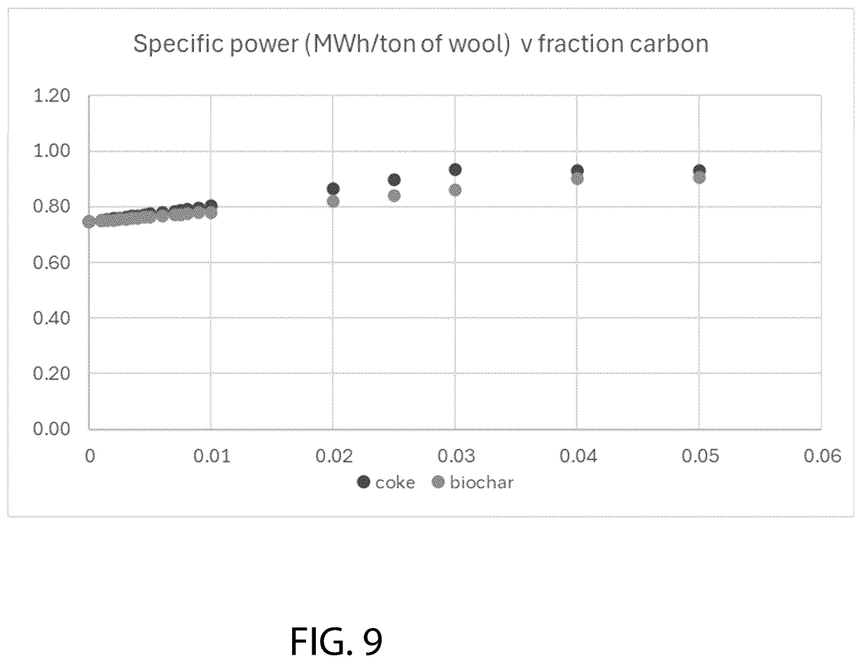

FIG. 10 is a graph of power supplied per ton of wool produced relative to amount of carbon;

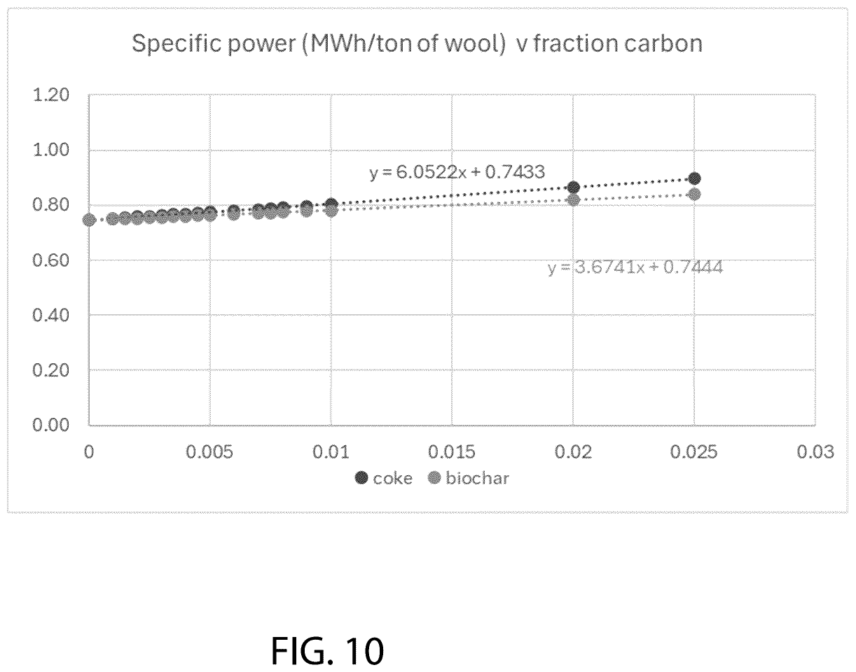

FIG. 11 is a graph of power supplied per ton of wool produced relative to amount of carbon;

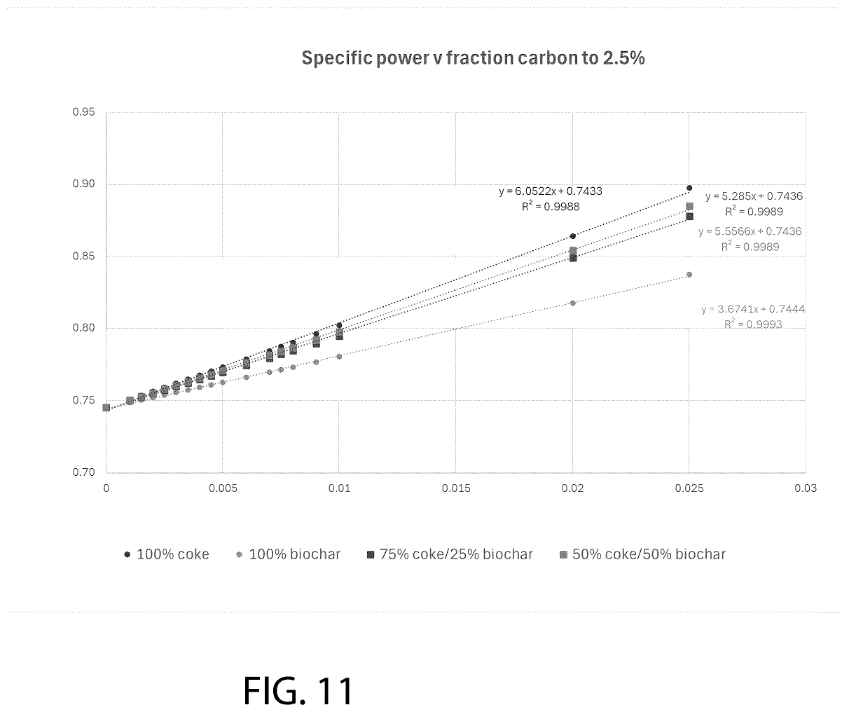

FIG. 12 is a graph of MnO reduced relative to amount of carbon;

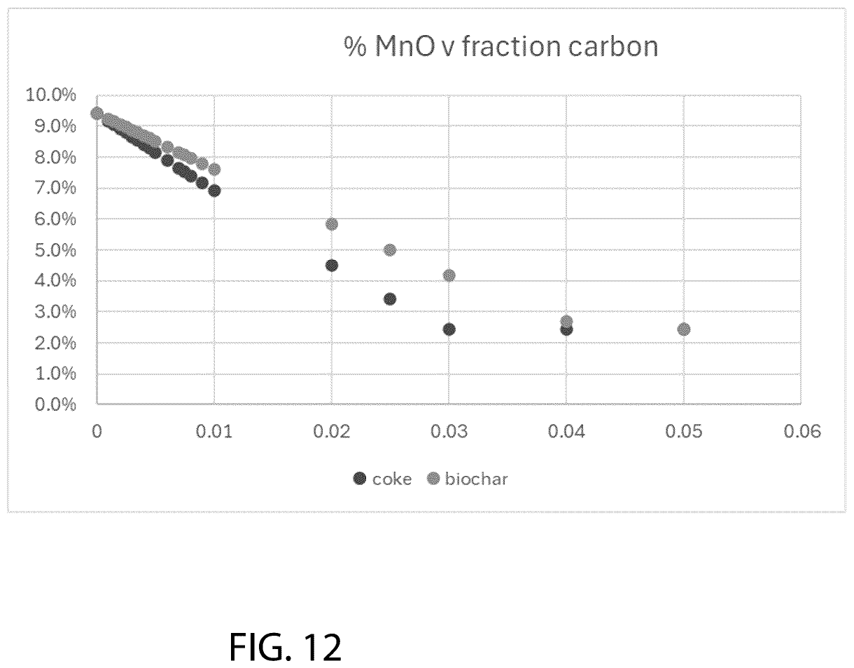

FIG. 13 is a graph of MnO reduced relative to amount of carbon;

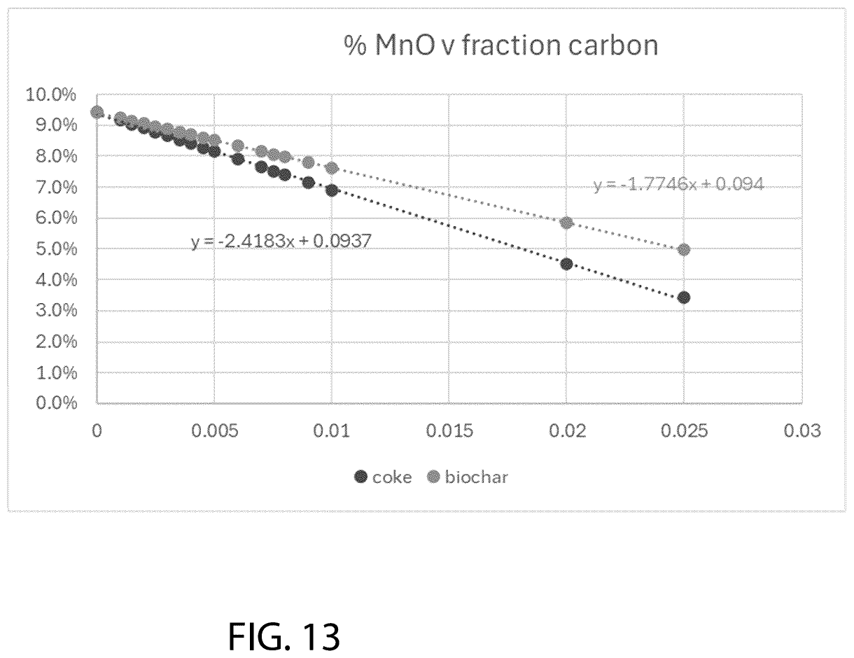

FIG. 14 is a graph of MnO reduced relative to amount of carbon;

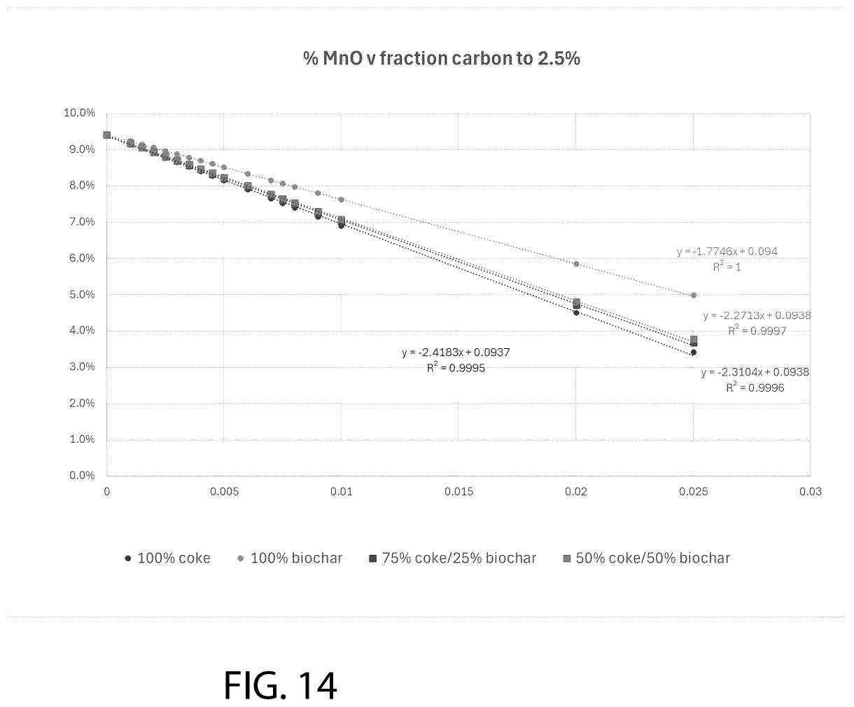

FIG. 15 is a graph of SiO₂ reduced relative to amount of carbon;

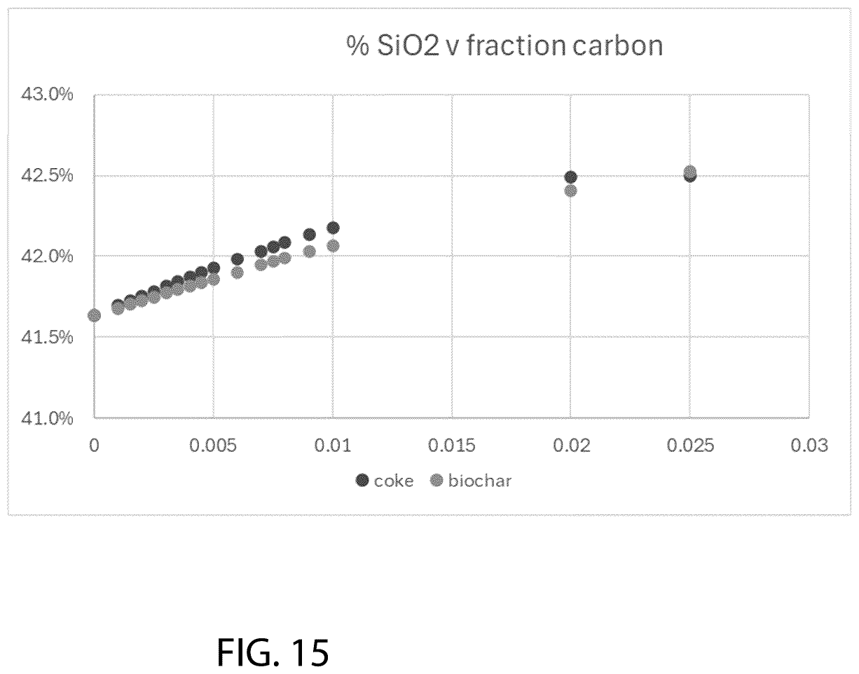

FIG. 16 is a graph of SiO₂ reduced relative to amount of carbon;

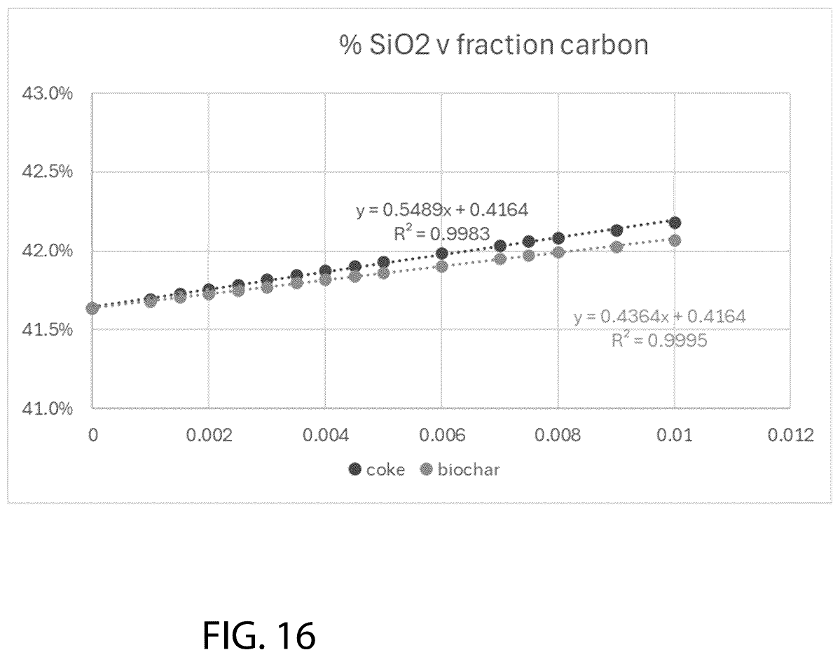

FIG. 17 is a graph of SiO₂ reduced relative to amount of carbon;

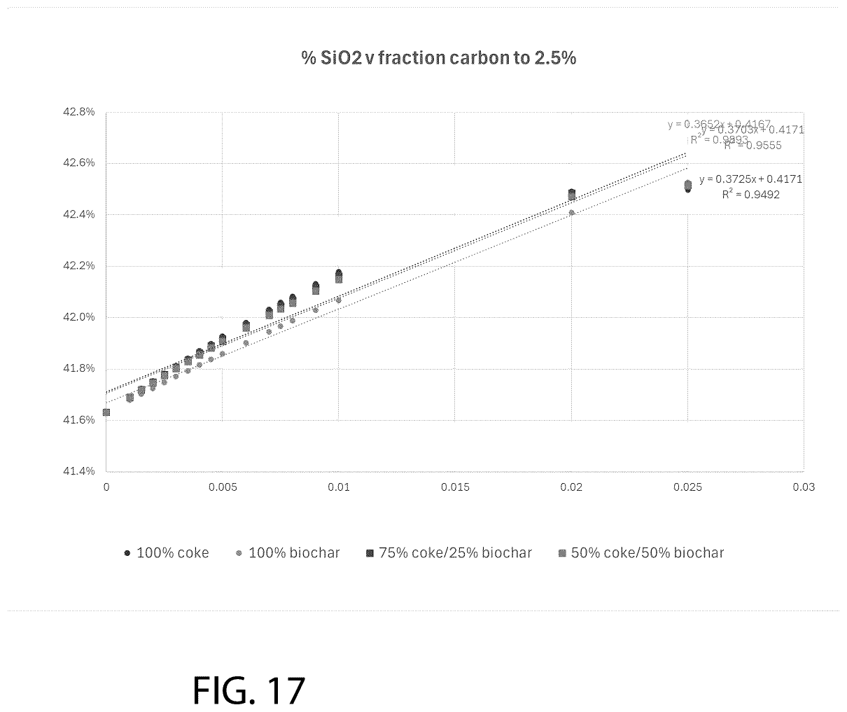

FIG. 18 is a graph of SiO₂ reduced relative to amount of carbon;

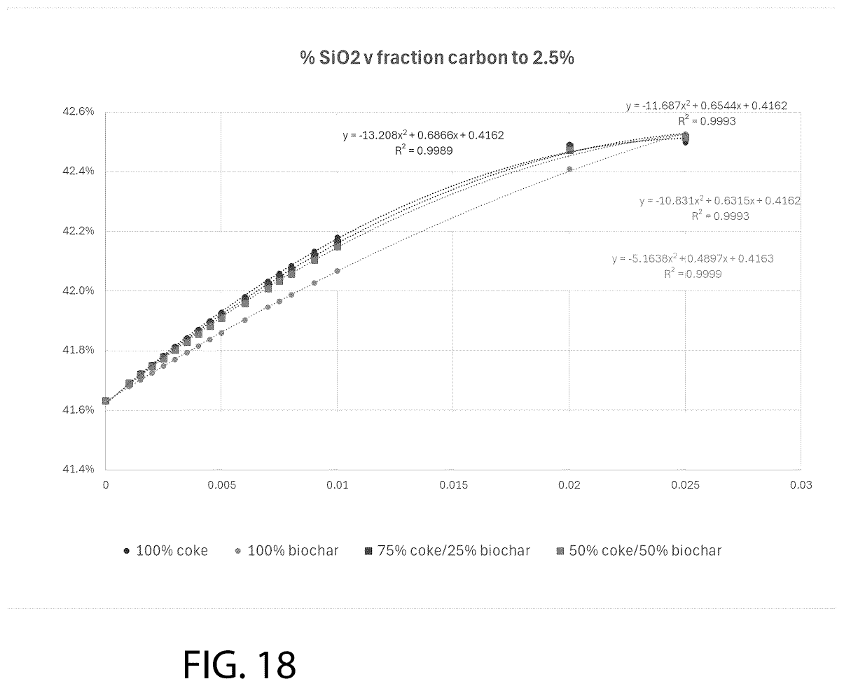

FIG. 19 is a graph of Al₂O₃ reduced relative to amount of carbon;

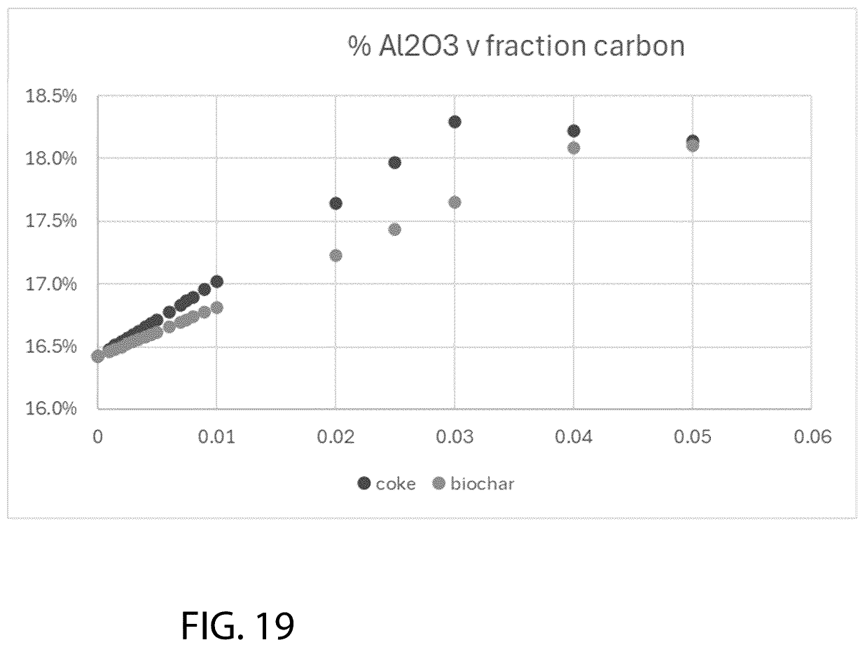

FIG. 20 is a graph of Al₂O₃ reduced relative to amount of carbon;

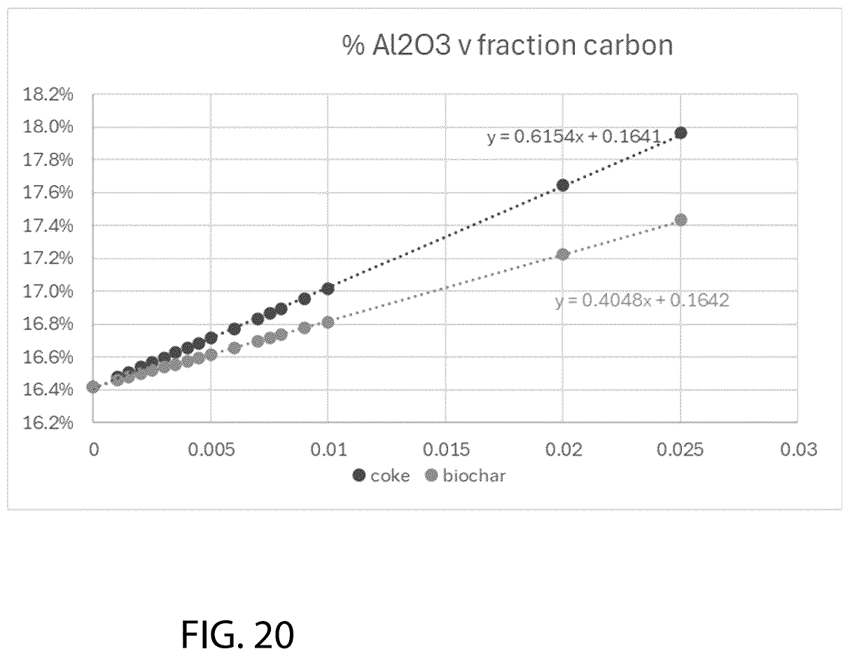

FIG. 21 is a graph of Al₂O₃ reduced relative to amount of carbon;

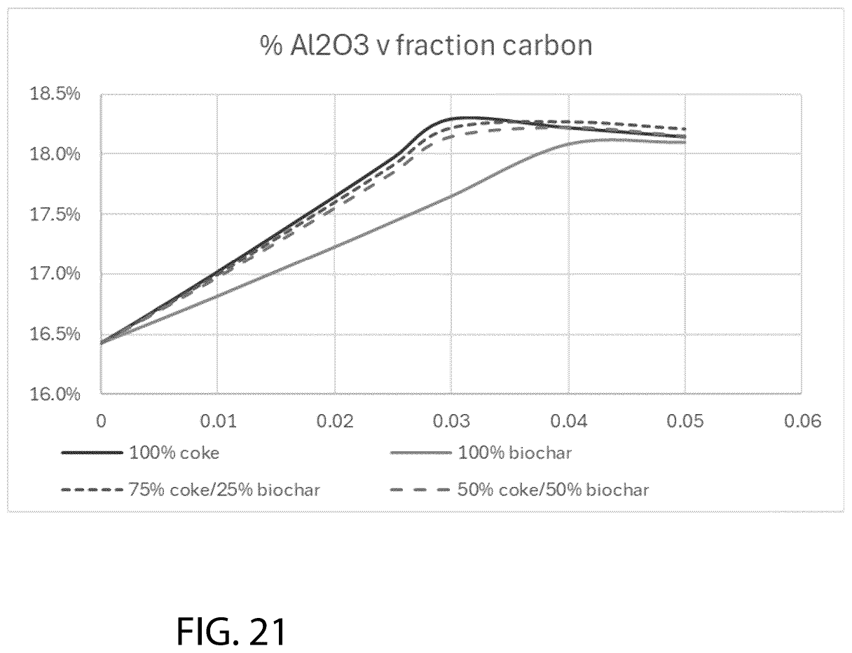

FIG. 22 is a graph of Al₂O₃ reduced relative to amount of carbon;

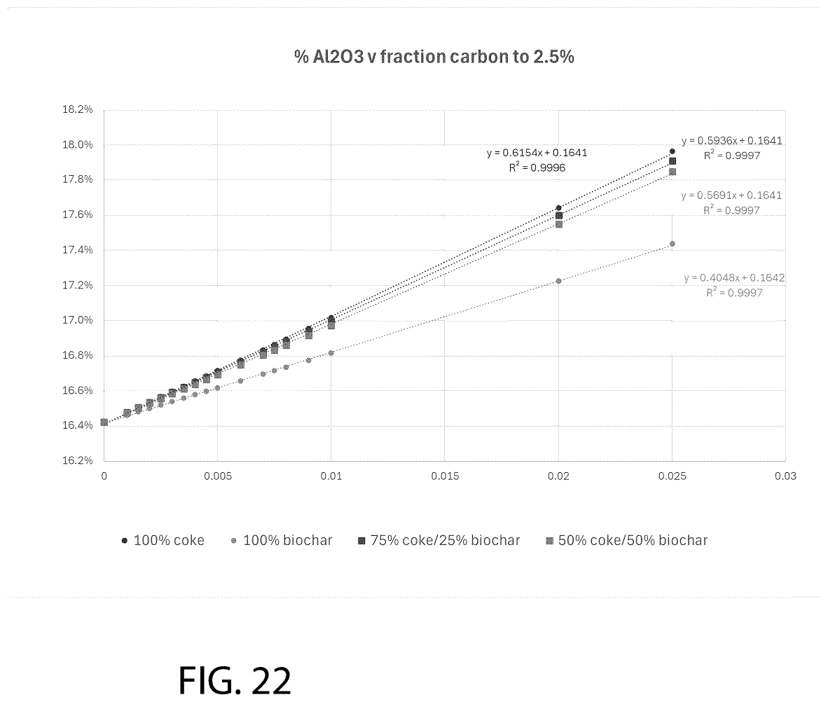

FIG. 23 is a graph of viscosity relative to amount of carbon;

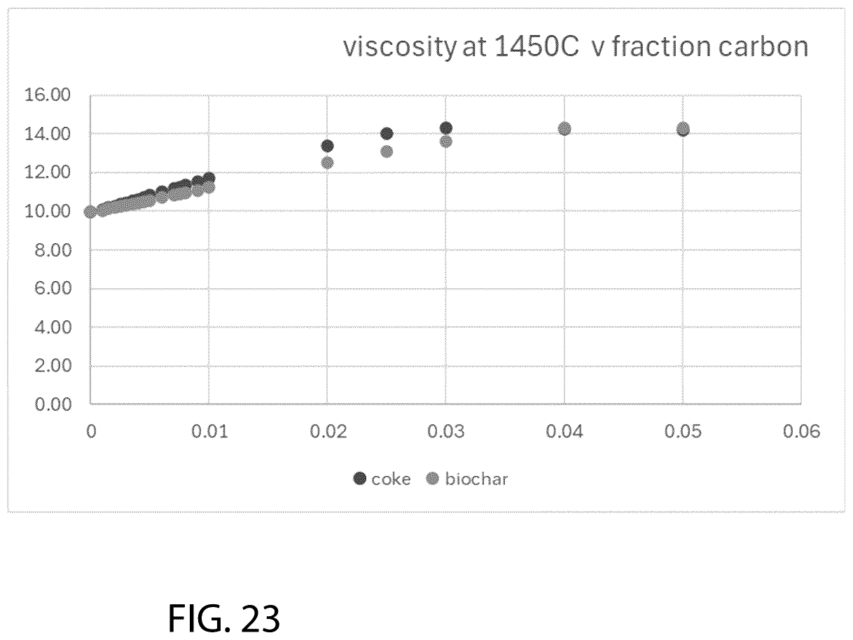

FIG. 24 is a graph of viscosity relative to amount of carbon;

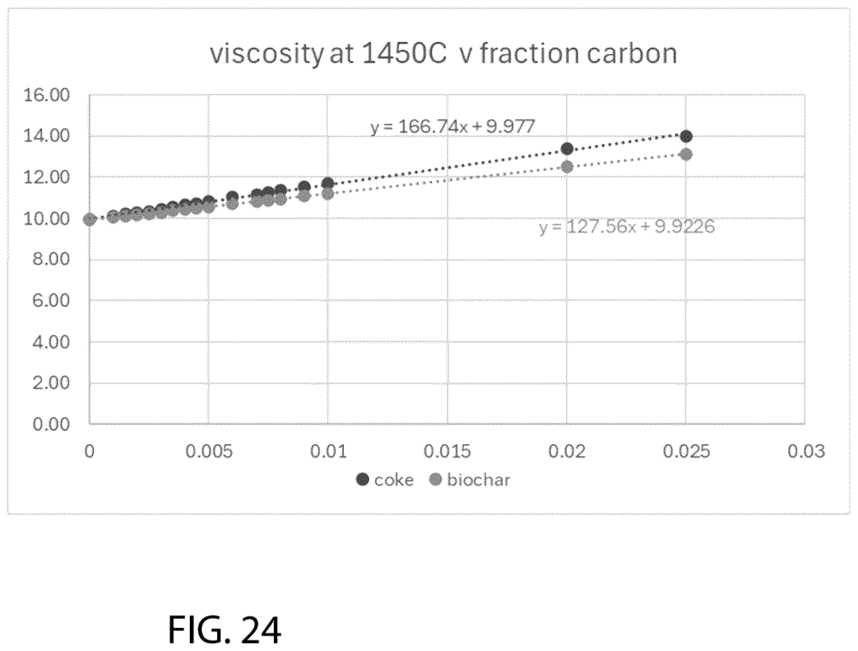

FIG. 25 is a graph of viscosity relative to amount of carbon;

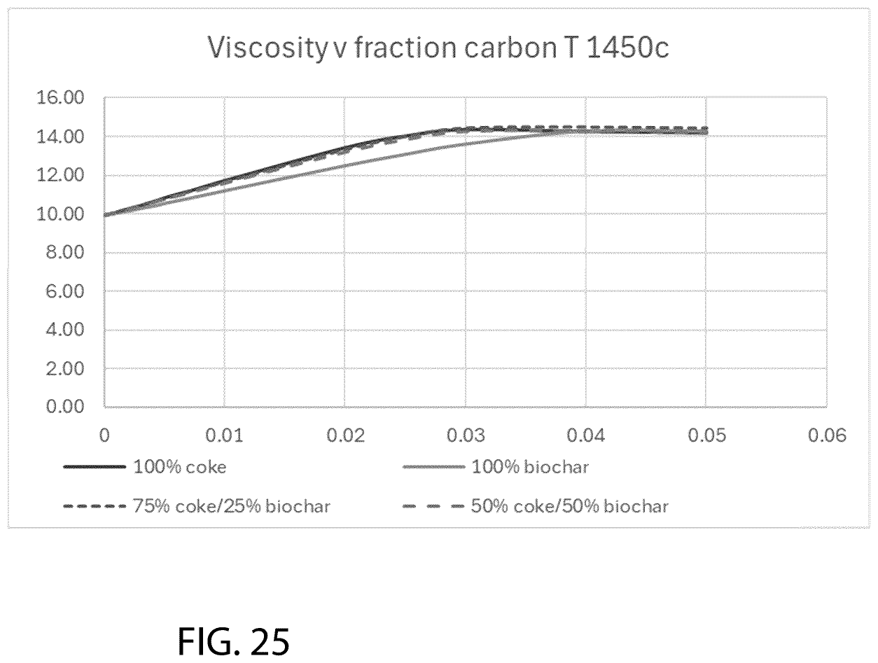

FIG. 26 is a graph of viscosity relative to amount of carbon; and

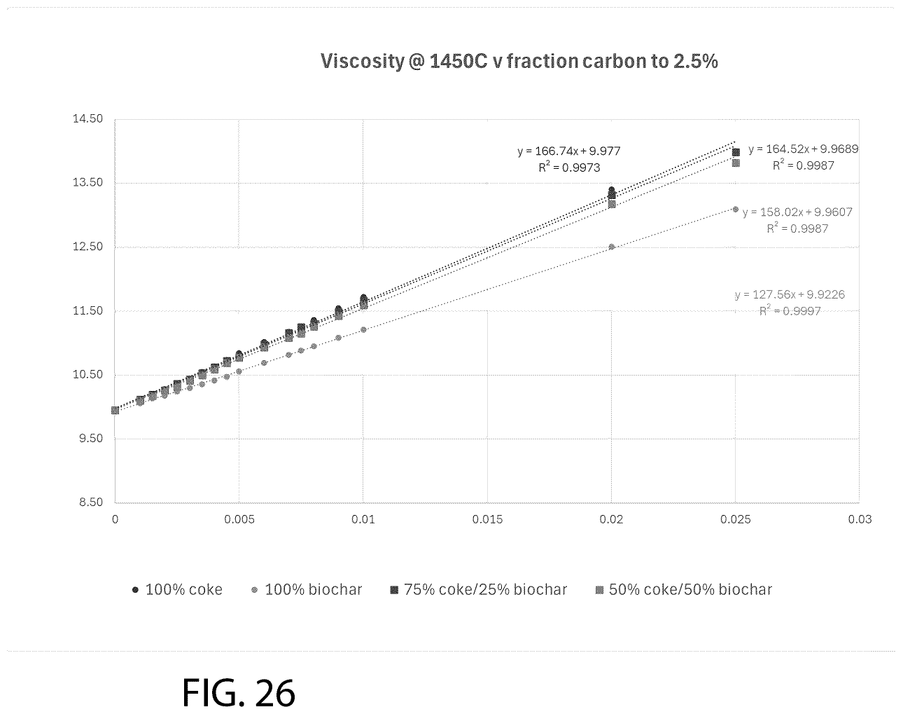

FIG. 27 is a graph of viscosity relative to temperature.

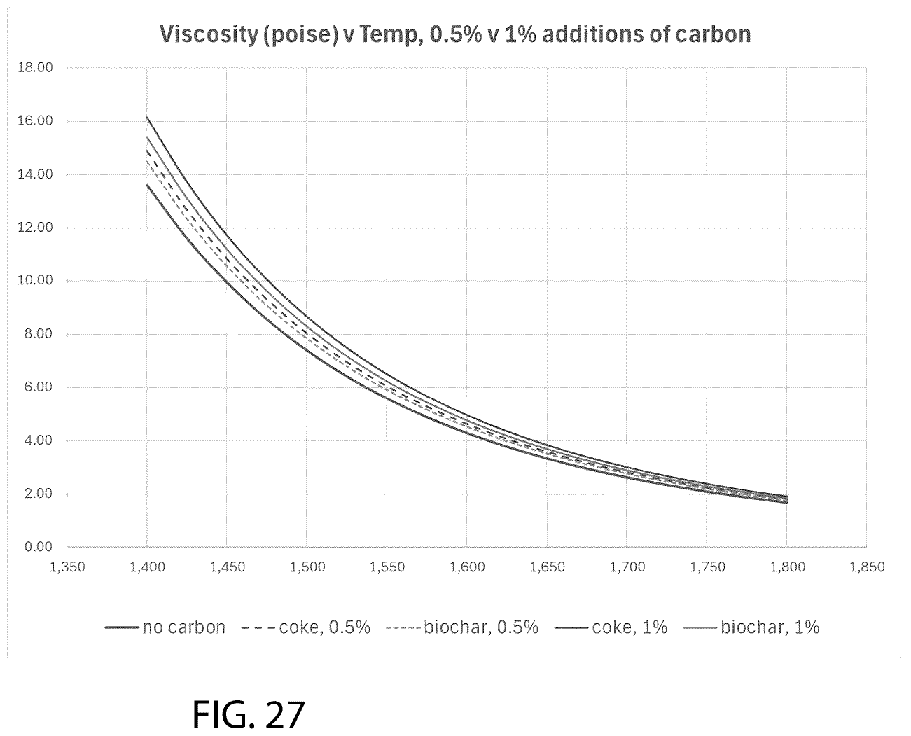

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means+/−5% of the reference value. According to the present application, the term “substantially free” less than about 0.1 wt. % based on the total of the referenced value.

The present disclosure relates to mineral wool building panels 100 and methods for manufacturing mineral wool fiber and building panels 100 from the mineral wool. The disclosed method utilizes predetermined, small amounts of carbon for selectively control the composition of the mineral wool fiber while reducing the environmental footprint. The disclosed method further yields increased amount of metal while controlling viscosity of the material.

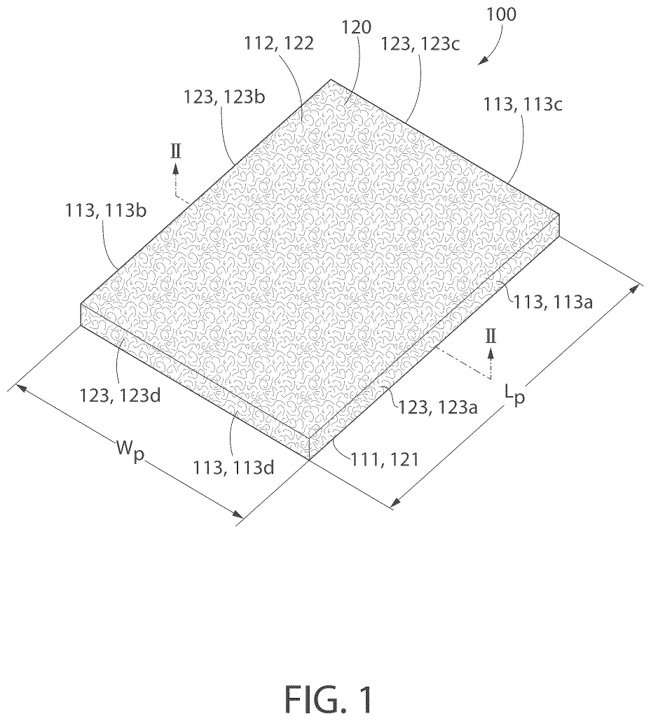

Referring to FIG. 1, the building panel 100 of the present invention may comprise a first major surface 111 opposite a second major surface 112. The ceiling panel 100 may further comprise a side surface 113 that extends between the first major surface 111 and the second major surface 112, thereby defining a perimeter of the ceiling panel 100.

The acoustic structure 100 includes a substrate 110 having a first major surface 112 opposite a second major surface 114 and a side surface 113 extending therebetween. The side surface includes a first side 113a, a second side 113b, a third side 113c, and a fourth side 113d. the building attachment hardware 70 may be coupled to the second side surface 113b of acoustic structure 100. In other examples, the building attachment hardware 70 may be coupled to either the first and/or second major surfaces 112, 114 of the acoustic structure 100 at a location immediately adjacent to the second side surface 113b of the acoustic structure 100.

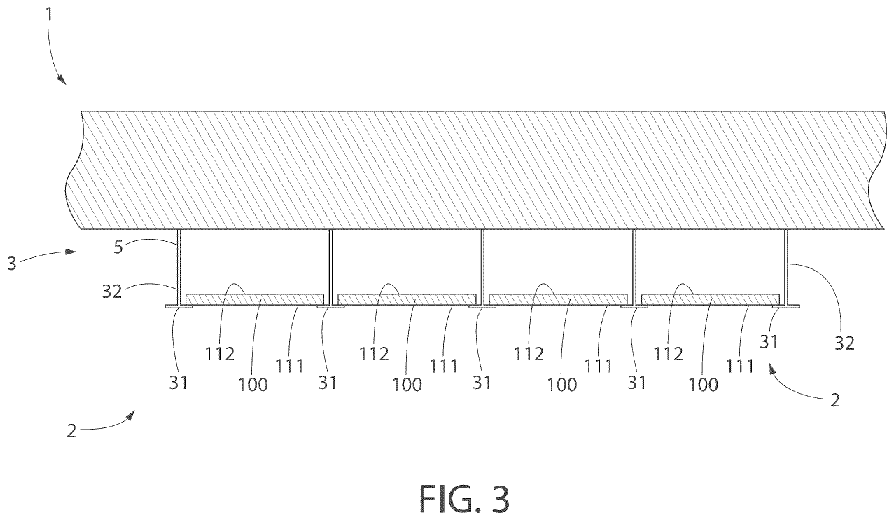

Referring to FIG. 3, the present invention may further include a ceiling system 1 comprising one or more of the building panels 100 installed in an interior space, whereby the interior space comprises a plenary space 3 and an active room environment 2. The plenary space 3 provides space for mechanical lines within a building (e.g., HVAC, plumbing, etc.). The active space 2 provides room for the building occupants during normal intended use of the building (e.g., in an office building, the active space would be occupied by offices containing computers, lamps, etc.).

In the installed state, the building panels 100 may be supported in the interior space by one or more parallel support struts 5. Each of the support struts 5 may comprise an inverted T-bar having a horizontal flange 31 and a vertical web 32. The ceiling system 1 may further comprise a plurality of first struts that are substantially parallel to each other and a plurality of second struts that are substantially perpendicular to the first struts (not pictured). In some embodiments, the plurality of second struts intersects the plurality of first struts to create an intersecting ceiling support grid. The plenary space 3 exists above the ceiling support grid and the active room environment 2 exists below the ceiling support grid. In the installed state, the first major surface 111 of the building panel 100 faces the active room environment 2 and the second major surface 112 of the building panel 100 faces the plenary space 3.

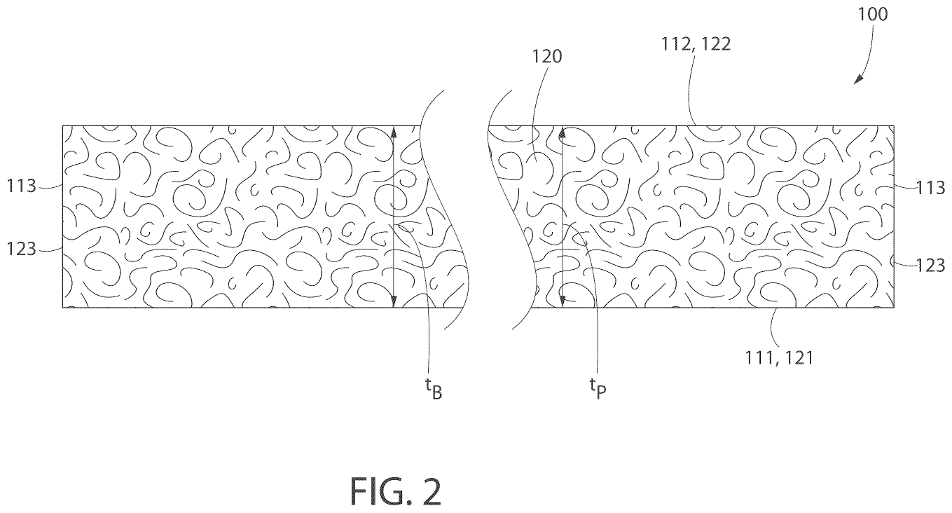

Referring now to FIGS. 1 and 2, the building panel 100 of the present invention may have a panel thickness t_{P} as measured from the first major surface 111 to the second major surface 112. The panel thickness t_{P} may range from about 4 mm to about 30 mm—including all values and sub-ranges there-between. In some embodiments, the panel thickness t_{P} may range from about 4 mm to about 12 mm—including all values and sub-ranges there-between. In some embodiments, the panel thickness t_{P} may range from about 5 mm to about 6 mm—including all values and sub-ranges there-between. In some embodiments, the panel thickness t_{P} may range from about 20 mm to about 25 mm—including all values and sub-ranges there-between.

The side surface 113 of the building panel 100 may comprise a first side surface 113a, a second side surface 113b, a third side surface 113c, and a fourth side surface 113d. The first side surface 113a may be opposite the second side surface 113b. The third side surface 113c may be opposite the fourth side surface 113d. The first and second side surfaces 113a, 113b may be substantially parallel to each other. The third and fourth side surfaces 113c, 113d may be substantially parallel to each other. The first and second side surfaces 113a, 113b may each intersect the third and fourth side surfaces 113c, 113d to form the perimeter of the ceiling panel 100.

The building panel 100 may have a panel length L_{P} as measured between the third and fourth side surfaces 113c, 113d (along at least one of the first and second side surfaces 113a, 113b). The panel length L_{P} may range from about 25.0 cm to about 300.0 cm—including all values and sub-ranges there-between. The building panel 100 may have a panel width W_{P} as between the first and second side surfaces 113a, 113b (and along at least one of the third and fourth side surfaces 113c, 113d). The panel width W_{P} may range from about 25.0 cm to about 125.0 cm—including all values and sub-ranges there-between. The panel length L_{P} may be the same or different than the panel width W_{P}.

The building panel 100 may comprise a body 120 having an upper surface 122 opposite a lower surface 121 and a body side surface 123 that extends between the upper surface 122 and the lower surface 121, thereby defining a perimeter of the body 120. The body 120 may have a body thickness t_{B} that extends from the upper surface 122 to the lower surface 121. The body thickness t_{B} may substantially equal to the panel thickness t_{P}.

The first major surface 111 of the building panel 100 may comprise the lower surface 121 of the body 120. The second major surface 112 of the building panel 100 may comprise the upper surface 122 of the body 120. When the first major surface 111 of the building panel 100 comprises the lower surface 121 of the body 120 and the second major surface 112 of the building panel 100 comprises the upper surface 122 of the body 120, the panel thickness t_{P} is substantially equal to the body thickness t_{B}.

The body side surface 123 may comprise a first body side surface 123a, a second body side surface 123b, a third body side surface 123c, and a fourth body side surface 123d. The first body side surface 123a may be opposite the second body side surface 123b. The third body side surface 123c may be opposite the fourth body side surface 123d. The first side surface 113a of the building panel 100 may comprise the first body side surface 123a of the body 120. The second side surface 113b of the building panel 100 may comprise the second body side surface 123b of the body 120. The third side surface 113c of the building panel 100 may comprise the third body side surface 123c of the body 120. The fourth side surface 113d of the building panel 100 may comprise the fourth body side surface 123d of the body 120.

The first and second body side surfaces 123a, 123b may each intersect the third and fourth body side surfaces 123c, 123d to form the perimeter of the body 120. The body 120 may have a width that is substantially equal to the panel width W_{P}—as measured between the first and second body side surfaces 123a, 123b. The body 120 may have a length that is substantially equal to the panel length L_{P}—as measured between the third and fourth body side surfaces 123c, 123d.

In some embodiments, a coating may be applied to the lower surface 121, first body side surface 123a, second body side surface 123b, third body side surface 123c, and/or fourth body side surface 123d of the body 120 (not pictured). The coating may be continuous or discontinuous. The coating may comprise pigment. In some embodiments, the building panel 100 may further comprise a non-woven scrim may be applied to the lower surface 121 of the body 120 (not pictured).

The body 120 may comprise a fibrous material. The body 120 may comprise a filler. The body 120 may comprise a binder.

The fibrous material may comprise an organic fiber. The fibrous material may comprise an inorganic fiber. Non-limiting examples of inorganic fiber include mineral wool (also referred to as slag wool), rock wool, stone wool, and glass fibers (fiberglass). Non-limiting examples of organic fiber include cellulosic fibers (e.g. paper fiber—such as newspaper, hemp fiber, jute fiber, flax fiber, wood fiber, or other natural fibers), polymer fibers (including polyester, polyethylene, aramid—i.e., aromatic polyamide, and/or polypropylene), protein fibers (e.g., sheep wool), and combinations thereof. Depending on the specific type of material, the fibers may either be hydrophilic (e.g., cellulosic fibers) or hydrophobic (e.g. fiberglass, mineral wool, rock wool, stone wool). The fibrous material may be present in an amount ranging from about 5 wt. % to about 99 wt. % based on the total dry weight of the body 120—including all values and sub-ranges there-between.

The phrase “dry-weight” refers to the weight of a referenced component without the weight of any carrier. Thus, when calculating the weight percentages of components in the dry-state, the calculation should be based solely on the solid components (e.g., binder, filler, fibrous material, etc.) and should exclude any amount of residual carrier (e.g., water, VOC solvent) that may still be present from a wet-state, which will be discussed further herein. According to the present invention, the phrase “dry-state” may also be used to indicate a component that is substantially free of a carrier, as compared to the term “wet-state,” which refers to that component still containing various amounts of carrier—as discussed further herein. The dry-state may refer to the coatings having a solids content of at least about 99 wt. % based on the total weight of the coating—such amount may allow for minor amounts (up to about 1 wt. %) of residual liquid carrier that may be present in the coating after drying.

Non-limiting examples of binder may include a starch-based polymer, polyvinyl alcohol (PVOH), a latex, polysaccharide polymers, cellulosic polymers, protein solution polymers, an acrylic polymer, polymaleic anhydride, polyvinyl acetate, epoxy resins, or a combination of two or more thereof. The binder may be present in an amount ranging from about 1.0 wt. % to about 25.0 wt. % based on the total dry weight of the air-permeable body 100—including all percentages and sub-ranges there-between. In a preferred embodiment, the binder may be present in an amount ranging from about 3.0 wt. % to about 10.0 wt. % based on the total dry weight of the air-permeable body 100—including all percentages and sub-ranges there-between.

Non-limiting examples of filler may include powders of calcium carbonate, including limestone, aragonite, titanium dioxide, sand, barium sulfate, clay, mica, dolomite, silica, talc, perlite, polymers, gypsum, wollastonite, expanded-perlite, calcite, aluminum trihydrate, pigments, zinc oxide, or zinc sulfate. The filler may be present in an amount ranging from about 0 wt. % to about 80 wt. % based on the total dry weight of the body 120—including all values and sub-ranges there-between. In other embodiments, the filler may be present in an amount ranging from about 5 wt. % to about 70 wt. % based on the total dry weight of the body 120—including all values and sub-ranges there-between.

In non-limiting embodiments, the body 120 may further comprise one or more additives include defoamers, wetting agents, biocides, dispersing agents, flame retardants (such as alumina tri-hydrate), and the like. The additive may be present in an amount ranging from about 0.01 wt. % to about 30 wt. % based on the total dry weight of the body 120—including all values and sub-ranges there-between.

The body 120 may have a first density ranging from about 2 lb/ft³ to about 16 lb/ft³—including all densities and sub-ranges there-between.

The body 120 of the present invention may have a porosity ranging from about 60% to about 98%—including all values and sub-ranges there between. In a preferred embodiment, the body 120 has a porosity ranging from about 75% to 95%—including all values and sub-ranges there between. In a preferred embodiment, the body 120 has a porosity ranging from about 85% to 95%—including all values and sub-ranges there between.

According to the present invention, porosity refers to the following:

$$\% Porosity = [ {V}_{Total} - ( {V}_{Binder} + {V}_{Fiber} + {V}_{CMC} + {V}_{Filler} ) ] / {V}_{Total}$$

Where V_{Total} refers to the total volume of the body 120 defined by the upper surface 122, the lower surface 121, and the body side surfaces 123. V Binder refers to the total volume occupied by the latex binder in the body 120. V_{Fiber} refers to the total volume occupied by the fibers 130 in the body 120. V_{Filler} refers to the total volume occupied by the filler in the body 120. V_{CMC} refers to the total volume occupied by the charge-modifying component in the body 120. Thus, the % porosity represents the amount of free volume within the body 120.

Alternatively, the air flow resistance of the body 120 may be measured in terms of MKS Rayls and range from about 50 MKS Rayls to about 200 MKS Rayls—including all resistances and sub-ranges there-between. In a preferred embodiment, the airflow resistance of the body 120 may range from about 60 MKS Rayls to about 150 MKS Rayls—including all resistances and sub-ranges there-between. Airflow resistance, as measured in MKS Rayls, does not allow for lateral flow of air through the body. Therefore, when measuring MKS Rayls, air is only flowing between the first and second major surfaces 121, 122 of the body 120, and not the side surfaces 123 of the body 120.

The body 120 of the present invention may be porous enough to exhibit sufficient airflow for the resulting building panel 100 to have the ability to reduce the amount of reflected sound in a room. The reduction in amount of reflected sound in a room is expressed by a Noise Reduction Coefficient (NRC) rating as described in ASTM International test method C423. This rating is the average of sound absorption coefficients at four ⅓ octave bands (250, 500, 1000, and 2000 Hz), where, for example, a system having an NRC of 0.90 has about 90% of the absorbing ability of an ideal absorber. A higher NRC value indicates that the material provides better sound absorption and reduced sound reflection.

The building panel 100 of the present invention exhibits an NRC of at least about 0.5. In a preferred embodiment, the building panel 100 of the present invention may have an NRC ranging from about 0.60 to about 0.99—including all value and sub-ranges there-between.

In addition to reducing the amount of reflected sound in a single room environment, the building panel 100 of the present invention should also be able to exhibit superior sound attenuation—which is a measure of the sound reduction between an active room environment 2 and a plenary space 3. ASTM has developed test method E1414 to standardize the measurement of airborne sound attenuation between room environments 3 sharing a common plenary space 3. The rating derived from this measurement standard is known as the Ceiling Attenuation Class (CAC). Ceiling materials and systems having higher CAC values have a greater ability to reduce sound transmission through the plenary space 3—i.e. sound attenuation function. The building panels 100 of the present invention may exhibit a CAC value of 30 or greater, preferably 35 or greater.

The body 120 of the building panel 100 of the present invention may comprise inorganic fiber. The inorganic fiber may be produced by spinning a smelting byproduct. The smelting byproduct may be formed from a smelting process.

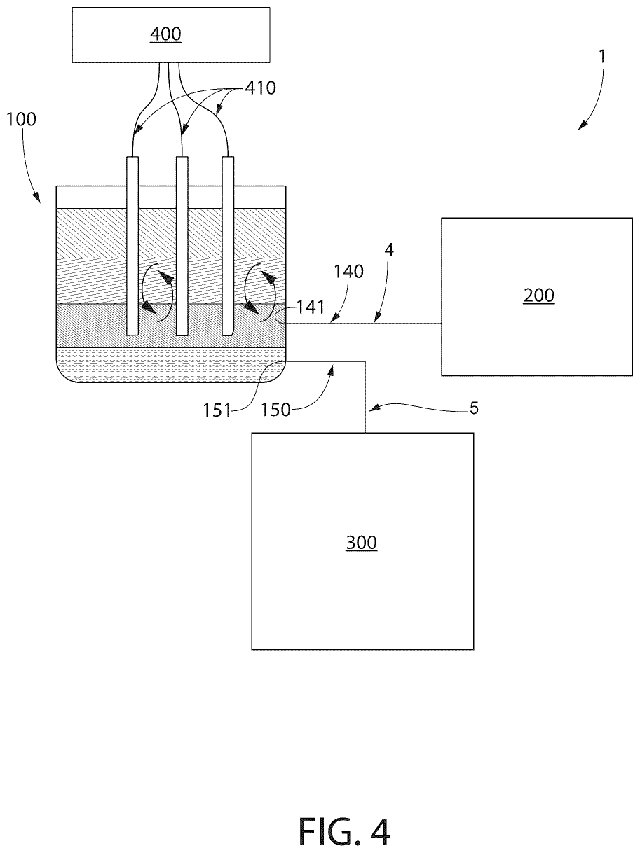

Referring now to FIG. 4, the present invention further includes a smelting process and related smelting system for smelting a starting composition into a smelting byproduct and a metal—whereby the smelting byproduct of the present invention may be further processed into the inorganic fiber. The inorganic fiber may be a vitreous fiber. The smelted metal may be subsequently collected and further processed based on relevant demand or applications.

The inorganic fiber may comprise one or more of SiO₂; Al₂O₃; MnO; MgO; CaO; TiO₂; Fe₂O₃T; Na₂O; K₂O; and P₂O₅. The SiO₂ in an amount ranging from about 35 wt. % to about 50 wt. % based on the total weight of the inorganic fiber—including all wt. % and sub-ranges there-between. The Al₂O₃ in an amount ranging from about 2 wt. % to about 22 wt. % based on the total weight of the inorganic fiber—including all wt. % and sub-ranges there-between. The MnO in an amount ranging from about 1.5 wt. % to about 11 wt. % based on the total weight of the inorganic fiber—including all wt. % and sub-ranges there-between. The MgO in an amount ranging from about 3 wt. % to about 10 wt. % based on the total weight of the inorganic fiber—including all wt. % and sub-ranges there-between. The CaO in an amount ranging from about 15 wt. % to about 30 wt. % based on the total weight of the inorganic fiber—including all wt. % and sub-ranges there-between. The total amount of SiO₂, Al₂O₃, MnO, MgO, CaO sum to an amount less than 100 wt. % based on the total weight of the inorganic fiber.

The TiO₂ in an amount ranging from about 0.15 wt. % to about 0.6 wt. % based on the total weight of the inorganic fiber—including all wt. % and sub-ranges there-between. The Fe₂O₃T in an amount ranging from a non-zero wt. % to about 0.5 wt. % based on the total weight of the inorganic fiber—including all wt. % and sub-ranges there-between. The Na₂O in an amount ranging from a non-zero wt. % to about 1 wt. % based on the total weight of the inorganic fiber—including all wt. % and sub-ranges there-between. The K₂O in an amount ranging from about 0.1 wt. % to about 3 wt. % based on the total weight of the inorganic fiber—including all wt. % and sub-ranges there-between. The P₂O₅ in an amount ranging from about 0.01 wt. % to about 0.1 wt. % based on the total weight of the inorganic fiber—including all wt. % and sub-ranges there-between. The total amount of SiO₂, TiO₂, Al₂O₃, Fe₂O₃T, MnO, MgO, CaO, Na₂O, K₂O, and P₂O₅ sum to an amount no more than 100 wt. % based on the total weight of the inorganic fiber.

In some embodiments, the SiO₂ may be present in an amount of about 37 wt. % to about 45 wt. %, or from about 41 wt. % to about 42 wt. % based on the total weight of the inorganic fiber. In some embodiments, the Al₂O₃ in an amount ranging from about 14 wt. % to about 20 wt. % or from about 11 wt. % to about 12 wt. % based on the total weight of the inorganic fiber. In some embodiments, the MnO in an amount ranging from 4 wt. % to about 10 wt. % or from about 2.5 wt. % to about 3.5 wt. % based on the total weight of the inorganic fiber. In some embodiments, the MgO in an amount ranging from about 5 wt. % to about 15 wt. % or from about 4 wt. % to about 5 wt. % based on the total weight of the inorganic fiber. In some embodiments, the CaO in an amount ranging from about 18 wt. % to about 28 wt. % or from 36 wt. % to about 38 wt. % based on the total weight of the inorganic fiber.

In some embodiments, the TiO₂ in an amount ranging from about 0.2 wt. % to about 0.5 wt. % or from about 0.42 wt. % to about 0.46 wt. % based on the total weight of the inorganic fiber. In some embodiments, the Fe₂O₃ in an amount ranging from a non-zero amount to about 0.5 wt. % or from about 0.2 wt. % to about 0.3 wt. % based on the total weight of the inorganic fiber. In some embodiments, the Na₂O in an amount ranging from a non-zero amount to about 1 wt. % or from about 0.2 wt. % to about 0.25 wt. % based on the total weight of the inorganic fiber. In some embodiments, the K₂O in an amount ranging from about 0.1 wt. % to about 3 wt. % or from about 1.15 wt. % to about 1.25 wt. % based on the total weight of the inorganic fiber. In some embodiments, the P₂O₅ in an amount ranging from about 0.01 wt. % to about 0.1 wt. % or from about 0.02 wt. % to about 0.04 wt. % based on the total weight of the inorganic fiber.

In some embodiments of the present invention, the starting composition may be an ore. In other embodiments, the starting composition may be a slag. The term “ore” refers to a naturally occurring substance containing one or more metals. The ore may be a mineral or take the form of a sediment or rock (i.e., an aggregate of one or more minerals). The term “slag” refers to a glass-like byproduct of a smelting process, whereby metal is the other product of the smelting process. In a non-limiting example, the smelting process may be performed by applying heat to an ore in the presence of one or more smelting additives, such as a reducing agent, to separate the metal and slag—as discussed in greater detail herein. During the smelting process, SO3 may be present in an amount ranging from about 0.05 wt. % to about 0.3 wt. %.

The system 1 of the present invention comprises a furnace 100. The furnace 100 may comprise a chamber with a chamber volume located therein.

The furnace 100 may comprise a first outlet 140. The first outlet 140 may comprise a first opening 141 and a second opening 142 that allows for fluid communication from inside of the chamber 110 to outside of the chamber 110.

The furnace 100 may comprise a second outlet 150. The second outlet 150 may comprise a first opening 151 and a second opening 152 that allows for fluid communication from inside of the chamber to outside of the chamber.

The furnace 100 may further comprise at least two electrodes. In some embodiments, the furnace 100 may comprise two, three, four, five, six, seven, eight, or nine electrodes. Each electrode has an electrode body. Each electrode body may be formed of carbon. In a non-limiting example, the electrode body may be formed of graphite.

The furnace may further comprise one or more sensors. The sensors may include a temperature sensor—such as a thermocouple—for monitoring the temperature inside of the chamber of the furnace during smelting, as discussed in greater detail herein.

The system 1 of the present invention may further comprise a power control device 400. The power control device 400 may include a power source—such as an AC or DC power generator—as well as power supply lines 410 capable of transmitting power generated by the power source to the electrodes of the furnace 100. The power control device 400 may further comprise a CPU that can collect data relating to the temperature of the furnace 100 that is collected by the temperature sensors.

The smelting process may comprise step a) of introducing a starting material into the furnace 100 that comprises a collection zone. In some embodiments, step a) may further comprise introducing a smelting additive with the starting material into the submerged arc furnace. The combination of starting material and smelting additive may form a smelting blend.

The smelting blend may comprise the smelting additive in an amount ranging from about 0.1 wt. % to about 7.0 wt. % based on the total weight of the smelting blend—including all weight percentage and sub-ranges there-between. In some embodiments, the smelting blend may comprise the smelting additive in an amount ranging from about 0.1 wt. % to about 5.0 wt. % based on the total weight of the smelting blend—including all weight percentage and sub-ranges there-between. In some embodiments, the smelting blend may comprise the smelting additive in an amount ranging from about 0.25 wt. % to about 5.0 wt. % based on the total weight of the smelting blend—including all weight percentage and sub-ranges there-between. In some embodiments, the smelting blend may comprise the smelting additive in an amount ranging from about 0.25 wt. % to about 4.0 wt. % based on the total weight of the smelting blend—including all weight percentage and sub-ranges there-between. In some embodiments, the smelting blend may comprise the smelting additive in an amount ranging from about 1.0 wt. % to about 2.0 wt. % based on the total weight of the smelting blend—including all weight percentage and sub-ranges there-between. In some embodiments, the smelting blend may comprise the smelting additive in an amount ranging from about 1.0 wt. % to about 1.5 wt. % based on the total weight of the smelting blend—including all weight percentage and sub-ranges there-between.

The starting material may be an ore. In some embodiments, the starting material may be a slag. In a non-limiting embodiment, the slag may be selected from a blast furnace slag, a steel slag, silicomanganese slag, ferro-silicomanganese slag, or a mixture of various slags. In a non-limiting example, the ore may include gabbro, basalt, bauxite, or manganese.

The smelting additive may comprise a reducing agent. Non-limiting examples of the smelting additive may include lime, alumina, limestone, aragonite, feldspar, gravel, calcium aluminate, biochar, recycled secondary slag, recycled fiber, coke, and blends thereof. In some embodiments the smelting additive will include a significant % of carbon. In some embodiments, the smelting additive may be coke, coal or biochar.

The term biochar may be interchangeable with the term “biocoal” and refers to pyrolyzed biomass. Biochar production removes carbon dioxide directly from the atmosphere through uptake by plants—thereby allowing an actual reduction of atmospheric carbon dioxide levels. With this in mind, the creation of acoustic panels comprising a body formed, in part, of biochar helps reduce carbon footprint and thereby alleviate global warming potential as biochar is a carbon negative material—i.e., production eliminates CO₂ from the atmosphere.

In some embodiments, the smelting additive will be substantially free of carbon. In some embodiments, the smelting additive will be substantially free of coal, graphite, coke, and the like. In some embodiments, the smelting additive will be biochar. While the electrodes may comprise graphite, the smelting additive may still be substantially free of graphite.

The disclosure utilizes small additions of carbon during processing of the mineral wool for selectively controlling the fiber chemistry. The disclosed method may include using biochar for controlling the fiber chemistry, coke for controlling the fiber chemistry, or a combination of biochar and coke for controlling the fiber chemistry.

The following discussion will be made in reference to silicomanganese slag as the starting material—however, the application is not limited to such silicomanganese slag as the starting material or related smelting byproducts and metals.

The method further includes step b), applying heat to electrodes by resistance heating. Subsequently the method includes step c), where the silicomanganese slag and the smelting additives react in the present of the heat to cause a redox reaction, thereby releasing pure metal (herein referred to as “metal”) and a smelting byproduct from the silicomanganese slag starting material. Smelting may occur by heating to a temperature ranging from about 1100° C. to about 1700° C.—including all temperatures and sub-ranges-therebetween. In some embodiments, the smelting may occur by heating to a temperature ranging from about 1100° C. to about 1500° C.—including all temperatures and sub-ranges-therebetween.

The term “pure metal” may refer to a composition comprising at least about 65% by weight of the reference metal or metal-alloy, with the remaining amounts accounted for material that is not the metal or metal alloy. In a non-limiting example, pure silicomanganese may refer to a composition containing about 60-72 wt. % of manganese, about 10 wt. % to about 25 wt. % of silicon—whereby the remaining amounts may include about 10 wt. % to about 25 wt. % of iron and trace amounts of carbon (less than 3.5 wt. %), phosphorus (less than 0.25 wt. %), and sulfur (less than 0.1 wt. %).

In some embodiments, the pure metal may meet one of Grade A, Grade B, or Grade C established as by ASTM A483 Composition Requirements. In a non-limiting example, Grade A pure silicomanganese may comprise about 65 wt. % to about 68 wt. % of manganese, about 18.5 wt. %.

According to this embodiment of the present invention, the smelting byproduct is a secondary slag. The term “secondary slag” refers to a composition that has been subjected to at least two smelting processes—i.e., two separate redox reactions. According to this embodiment, the pure metal may be a silicomanganese metal.

According to other embodiments where the starting material is not a slag but rather an ore, the smelting byproduct is also a slag but is not a secondary slag, as the byproduct has been subjected to only a single smelting process.

According to the embodiments where the starting material is a slag—specifically, a silicomanganese slag—the starting material may comprise a first composition that includes silicon dioxide, manganese oxide, magnesium oxide, and calcium oxide. In some embodiments, the first composition of the slag starting material may further comprise titanium dioxide, aluminum oxide, iron oxide, sodium oxide, and potassium oxide.

In a non-limiting example, the silicomanganese slag as a starting material may comprise silicon dioxide in an amount ranging from about 30 wt. % to about 60 wt. %; titanium dioxide in an amount ranging from about 0 wt. % to about 2 wt. %; aluminum oxide in an amount ranging from about 0 wt. % to about 30 wt. %; manganese oxide in an amount ranging from about 2 wt. % to about 30 wt. %; magnesium oxide in an amount ranging from about 1 wt. % to about 17 wt. %; calcium oxide in an amount ranging from about 10 wt. % to about 40 wt. %; sodium oxide in an amount ranging from about 0 wt. % to about 2 wt. %; and potassium oxide in an amount ranging from about 0 wt. % to about 3 wt. %.

According to the embodiments where the starting material is a slag—specifically, a silicomanganese slag—the secondary slag may comprise a second composition that includes silicon dioxide, aluminum oxide, manganese oxide, magnesium oxide, and calcium oxide. In some embodiments, the first composition of the slag starting material may further comprise titanium dioxide, iron oxide, sodium oxide, and potassium oxide.

In a non-limiting example, the silicomanganese slag as a starting material may comprise silicon dioxide in an amount ranging from about 30 wt. % to about 50 wt. %; titanium dioxide in an amount ranging from about 0 wt. % to about 1 wt. %; aluminum oxide in an amount ranging from about 6 wt. % to about 25 wt. %; manganese oxide in an amount ranging from about 4 wt. % to about 16 wt. %; magnesium oxide in an amount ranging from about 1 wt. % to about 16 wt. %; calcium oxide in an amount ranging from about 15 wt. % to about 27 wt. %; sodium oxide in an amount ranging from about 0 wt. % to about 2 wt. %; and potassium oxide in an amount ranging from about 0 wt. % to about 3 wt. %.

Resistance heating may occur by applying power to the electrodes 130 present in the chamber, whereby at least one of the starting material (i.e., silicomanganese slag), the smelting byproduct (i.e., secondary slag), and the metal has an electrical resistance that results in heat being generated when the current passes through the respective component.

In some embodiments, the starting material (i.e., silicomanganese slag) may have a first electrical resistance that results in heat being generated when the current from the electrodes passes through the starting material. In some embodiments, the smelting byproduct (i.e., secondary slag) may have a second electrical resistance that results in heat being generated when the current from the electrodes passes through the smelting byproduct. In some embodiments, the metal may have a third electrical resistance that results in heat being generated when the current from the electrodes passes through the metal.

The first electrical resistance may form at least part of the electrical resistance that results in the resistance heating of the collection zone. The second electrical resistance may form at least part of the electrical resistance that results in the resistance heating of the collection zone. The third electrical resistance may form at least part of the electrical resistance that results in the resistance heating.

With the smelting byproduct (i.e., secondary slag) and the pure metal being formed from the redox reaction, the method further includes step c), gathering the metal in the lower portion of the collection zone and gathering the smelting byproduct in the upper portion of the collection zone. Specifically, due to density differential between the smelting byproduct (i.e., secondary slag) and the metal, the metal drops and settles down while the smelting byproduct remains in the upper portion of the furnace.

The smelting byproduct may be in a molten state when leaving the chamber of the furnace 100. The method may further comprise a step whereby the smelting byproduct may flow from the first outlet 140 to a fiber spinning apparatus 200 via the first fluid communication line 4. The first outlet 140 may be in fluid communication with the fiber spinning apparatus 200 via the first fluid communication line 4.

In some embodiments, the first fluid communication line 4 may function as a gravity feed. According to this embodiment, the smelting byproduct may leave the chamber in a molten state and be able to flow through the first fluid communication line 4 under the effects of gravity due to the natural head pressure within the chamber and the flowability of the smelting byproduct in the molten state.

Once the smelting byproduct reaches the fiber spinning apparatus 200, the smelting byproduct may be spun into the inorganic fiber, which may ultimately form part of the body 120 of the building panel 100 of the present invention.

The metal may be in a molten state when leaving the chamber of the furnace 100. Therefore, the method may further comprise a step whereby the metal may flow from the second outlet 150 to a post-processing or storage facility 300 via the second fluid communication line 5. The second outlet 150 may be in fluid communication with the post-processing or storage facility 300 via the second fluid communication line 5.

In some embodiments, the second fluid communication line 5 may function as a gravity feed. According to this embodiment, the metal may leave the chamber in a molten state and be able to flow through the second fluid communication line 5 under the effects of gravity due to the natural head pressure within the chamber and the flowability of the metal in the molten state.

Once the smelting byproduct reaches the fiber spinning apparatus 200, the smelting byproduct may be spun into inorganic fiber. The smelting byproduct may be spun into vitreous inorganic fiber. Non-limiting examples of inorganic fiber may have a diameter ranging from about 3 microns to about 12 microns.

The resulting inorganic fiber may be formed from the present smelting process, which incorporates biochar as the smelting additive.

While it is known to use carbon in cupulas for temperature control, this disclosure utilizes small amounts via coke and/or biochar to control viscosity of the slag and composition of the fiber. Typically in cupulas you are not smelting out significant amounts of metal like you are in this application; magnitude of orders more of metal are generated from this process than what is typically generated from a cupula operation using blast furnace slag, for example. Therefore, control of viscosity and composition is important and the addition of small amounts of carbon have been shown to be useful for both.

### EXEMPLARY CLAIMS

The disclosure may be further characterized by the following exemplary claims.

Exemplary claim 1. A method of smelting to form an inorganic fiber, the method comprising: a) introducing a silicomanganese slag and a smelting additive into a furnace, the smelting additive comprising biochar; b) smelting the silicomanganese slag in the presence of the smelting additive into a silicomanganese metal and a smelting byproduct; and c) flowing the smelting byproduct from the furnace from a first outlet to a fiber spinning apparatus; and step d) processing the smelting byproduct by the fiber spinning apparatus to form the inorganic fiber.

Exemplary claim 2. The method according to Exemplary claim 1, wherein the smelting additive further comprises coke.

Exemplary claim 3. The method according to Exemplary claim 1, wherein the inorganic fiber has a diameter ranging from about 3 microns to about 12 microns.

Exemplary claim 4. The method according to any one of Exemplary claims 1 to 2, wherein the smelting of the silicomanganese slag in step b) occurs at a temperature ranging from about 1100° C. to about 1800° C.

Exemplary claim 5. The method according to any one of Exemplary claims 1 to 4, wherein the smelting is performed by applying power to the silicomanganese slag such that the silicomanganese slag is smelted by resistance heating.

Exemplary claim 6. The method according to Exemplary claim 2, wherein the silicomanganese slag forms at least part of an electrical resistance that causes the resistance heating to occur.

Exemplary claim 7. The method according to any one of Exemplary claims 1 to 6, wherein the smelting byproduct comprises a first composition that includes silicon dioxide, aluminum oxide, manganese oxide, magnesium oxide, and calcium oxide.

Exemplary claim 8. A building panel comprising a first major exposed surface opposite a second major exposed surface, the building panel comprising a body having an upper surface opposite a lower surface, the body comprising the inorganic fiber according to any one of Exemplary claims 1 to 7; a binder; and a filler.

Exemplary claim 9. The building panel according to Exemplary claim 8, wherein the building panel exhibits an NRC value of at least 0.50.

Exemplary claim 10. The building panel according to Exemplary claim 9, wherein the building panel exhibits an NRC value ranging from about 0.60 to about 0.95.

Exemplary claim 11. The building panel according to any one of Exemplary claims 8 to 10, wherein the body has a porosity ranging from about 60% to about 98%.

Exemplary claim 12. The building panel according to any one of Exemplary claims 8 to 11, wherein the body has a density ranging from about 2 lb/ft3 to about 16 lb/ft3.

Exemplary claim 13. The building panel according to any one of Exemplary claims 8 to 12, wherein the binder is selected from one or more of a starch-based polymer, polyvinyl alcohol (PVOH), a latex, polysaccharide polymers, cellulosic polymers, protein solution polymers, an acrylic polymer, polymaleic anhydride, polyvinyl acetate, and epoxy resins.

Exemplary claim 14. The building panel according to any one of Exemplary claims 8 to 13, wherein the filler is selected from one or more of calcium carbonate, including limestone, aragonite, titanium dioxide, sand, barium sulfate, clay, mica, dolomite, silica, talc, perlite, polymers, gypsum, wollastonite, expanded-perlite, calcite, aluminum trihydrate, pigments, zinc oxide, and zinc sulfate.

Exemplary claim 15. A ceiling system comprising: at least one of the building panel according to any one of Exemplary claims 8 to 14; a plurality of support struts comprising a support flange; and wherein the support struts are configured to support the first major exposed surface of the building panel.

Exemplary claim 16. A system for the product of inorganic fiber from silicomanganese slag, the system comprising a power control device; a furnace comprising a chamber; a first outlet in fluid communication with the chamber; a second outlet in fluid communication with the chamber; and at least two electrodes; a fiber spinning apparatus in fluid communication with the first outlet of the collection zone; wherein a silicomanganese metal and a smelting additive comprising biochar are present in the chamber and the power control device is configured to apply power to the silicomanganese metal and biochar through the at least two electrodes; and wherein the fiber spinning apparatus is configured to spin a smelting byproduct formed from the silicomanganese metal and biochar.

Exemplary claim 17. The system according to Exemplary claim 16, wherein the fiber spinning apparatus is an inorganic fiber spinning apparatus.

Exemplary claim 18. The system according to any one of Exemplary claims 16 to 17, wherein the first outlet is in fluid communication with the fiber spinning apparatus via a gravity feed.

Exemplary claim 19. The system according to any one of Exemplary claims 16 to 18, wherein the smelting additive is substantially free of coke.

Exemplary claim 20. The system according to any one of Exemplary claims 16 to 19, wherein the furnace comprises three or more electrodes.

Exemplary claim 21. The system according to any one of Exemplary claims 16 to 20, wherein the chamber is substantially free of an external source of carbon.

Exemplary claim 22. An inorganic fiber comprising SiO2 in an amount ranging from about 35 wt. % to about 50 wt. % based on the total weight of the inorganic fiber; Al2O3 in an amount ranging from about 2 wt. % to about 22 wt. % based on the total weight of the inorganic fiber; MnO in an amount ranging from about 1.5 wt. % to about 11 wt. % based on the total weight of the inorganic fiber; MgO in an amount ranging from about 4 wt. % to about 20 wt. % based on the total weight of the inorganic fiber; and CaO in an amount ranging from about 15 wt. % to about 30 wt. % based on the total weight of the inorganic fiber; and wherein the total amount of SiO2, Al2O3, MnO, MgO, CaO sum to an amount less than 100 wt. % based on the total weight of the inorganic fiber.

Exemplary claim 23. The inorganic fiber according to Exemplary claim 22, further comprising TiO2 in an amount ranging from about 0.15 wt. % to about 0.6 wt. % based on the total weight of the inorganic fiber.

Exemplary claim 24. The inorganic fiber according to any one of Exemplary claims 22 to 23, further comprising Fe2O3T in an amount ranging from a non-zero wt. % to about 0.5 wt. % based on the total weight of the inorganic fiber.

Exemplary claim 25. The inorganic fiber according to any one of Exemplary claims 22 to 24, further comprising Na2O in an amount ranging from a non-zero wt. % to about 1 wt. % based on the total weight of the inorganic fiber.

Exemplary claim 26. The inorganic fiber according to any one of Exemplary claims 22 to 25, further comprising K2O in an amount ranging from 0.1 wt. % to about 3 wt. % based on the total weight of the inorganic fiber.

Exemplary claim 27. The inorganic fiber according to any one of Exemplary claims 22 to 26, further comprising P₂O₅ in an amount ranging from about 0.01 wt. % to about 0.1 wt. % based on the total weight of the inorganic fiber.

Exemplary claim 28. The inorganic fiber according to Exemplary claim 27, wherein the total amount of SiO2, TiO2, Al2O3, Fe2O3T, MnO, MgO, CaO, Na2O, K2O, and P2O5 sum to an amount no more than 100 wt. % based on the total weight of the inorganic fiber.

Exemplary claim 29. A building panel comprising a first major exposed surface opposite a second major exposed surface, the building panel comprising a body having an upper surface opposite a lower surface, the body comprising the inorganic fiber according to any one of Exemplary claims 22 to 27; a binder; and a filler.

Exemplary claim 30. The building panel according to Exemplary claim 29, wherein the building panel exhibits an NRC value of at least 0.5.

Exemplary claim 31. The building panel according to Exemplary claim 30, wherein the building panel exhibits an NRC value ranging from about 0.6 to about 0.95.

Exemplary claim 32. The building panel according to any one of Exemplary claims 29 to 31, wherein the body has a porosity ranging from about 60% to about 98%.

Exemplary claim 33. The building panel according to any one of Exemplary claims 29 to 32, wherein the body has a density ranging from about 2 lb/ft3 to about 16 lb/ft3.

Exemplary claim 34. The building panel according to any one of Exemplary claims 29 to 33, wherein the binder is selected from one or more of a starch-based polymer, polyvinyl alcohol (PVOH), a latex, polysaccharide polymers, cellulosic polymers, protein solution polymers, an acrylic polymer, polymaleic anhydride, polyvinyl acetate, and epoxy resins.

Exemplary claim 35. The building panel according to any one of Exemplary claims 29 to 34, wherein the filler is selected from one or more of calcium carbonate, including limestone, aragonite, titanium dioxide, sand, barium sulfate, clay, mica, dolomite, silica, talc, perlite, polymers, gypsum, wollastonite, expanded-perlite, calcite, aluminum trihydrate, pigments, zinc oxide, and zinc sulfate.

Exemplary claim 36. A ceiling system comprising: at least one of the building panel according to any one of Exemplary claims 29 to 35; a plurality of support struts comprising a support flange; and wherein the support struts are configured to support the first major exposed surface of the building panel.

### EXAMPLES

The following are Examples of the disclosure with corresponding carbon reaction rates. Samples using coke, biochar, and a combination of coke and biochar were tested for efficacy of composition control using selective amounts of carbon. Carbon reaction rates are a measure of efficacy of a carbon source, and indicate how rapidly and completely a reaction will occur. It is known that different types of carbon will react at different rates in a SiMn SAF.

The tests in the Examples were run in a tube furnace, where measures of evolved CO and CO₂ could be measured as temperature was increased. The metal generated was collected, though examination of the samples suggests that in most cases, additional metal had formed but had not been able to segregate and was trapped in the remaining slag as inclusions.

TABLE 1

| Sample | SiO₂ | TiO₂ | Al₂O₃ | Fe₂O₃T | MnO | MgO | CaO | Na₂O | K₂O | P₂O₅ | SO₃ |
|---|---|---|---|---|---|---|---|---|---|---|---|
| Slag 1 | 36.9 | 0.3 | 20.8 | 1.1 | 10.2 | 8.7 | 20.5 | 0.21 | 0.96 | 0.01 | 0.08 |
| Slag 2 | 43.9 | 0.1 | 8.6 | 0.32 | 8.9 | 14.4 | 22.4 | 0.19 | 0.45 | 0.01 | 0.07 |
| Slag 3 | 41.7 | 0.3 | 14.9 | 0.38 | 10.4 | 9.3 | 21.0 | 0.30 | 1.12 | 0.01 | 0.02 |
| Slag 4 | 39.6 | 0.2 | 21.6 | 0.11 | 9.3 | 6.6 | 21.3 | 0.25 | 1.05 | 0.00 | 0.05 |
| Slag 5 | 46.5 | 0.1 | 7.3 | 0.09 | 11.5 | 11.7 | 21.4 | 0.50 | 0.84 | 0.01 | 0.03 |
| blend 1 (50% | 40.0 | 0.2 | 16.1 | 0.26 | 9.2 | 10.9 | 21.6 | 0.19 | 0.98 | 0.01 | 0.09 |
| Slag 1, 40% | | | | | | | | | | | |
| slag 2, 10% | | | | | | | | | | | |
| slag 3) | | | | | | | | | | | |
| blend 2 (55% | 40.4 | 0.2 | 15.4 | 0.25 | 9.2 | 11.2 | 21.6 | 0.20 | 0.95 | 0.01 | 0.09 |
| Slag 1, 35% | | | | | | | | | | | |
| slag 2, 10% | | | | | | | | | | | |
| slag 3) | | | | | | | | | | | |
| blend 3; 60% | 42.4 | 0.2 | 15.9 | 0.10 | 10.2 | 8.6 | 21.3 | 0.35 | 0.97 | 0.00 | 0.04 |
| Slag 4, 40% | | | | | | | | | | | |
| slag 5 | | | | | | | | | | | |

TABLE 2

| | | | | rate of MnO | rate of SiO2 | |
|---|---|---|---|---|---|---|
| | | | | reduction to | reduction to | |
| | | | % carbon | Mn metal + | Si metal + | rate of SiMn |
| Case | Blend | Carbon | added, by | CO gas, | CO gas, | creation, |
| # | # | source | weight | In(conc)/hr | In(conc)/hr | In(conc)/hr |
| A | 1 | none | 0 | −0.39 | −0.58 | −0.49 |
| B | 1 | Coke 1 | 0.52 | −0.32 | −0.13 | −0.20 |
| C | 1 | Coke 2 | 0.52 | −0.75 | −0.38 | −0.26 |
| D | 2 | none | 0 | −0.36 | −0.42 | |
| E | 2 | Coke 1 | 0.52 | −0.40 | −0.23 | −0.09 |
| F | 2 | Coke 2 | 0.52 | −0.68 | −0.27 | −0.17 |
| G | 3 | biochar | 0.52 | −0.01 | — | — |
| H | 3 | biochar | 0.81 | −0.25 | −0.15 | −0.11 |
| I | 4 | biochar | 1.6 | −0.30 | −0.16 | −0.12 |

TABLE 3

| | | | % carbon | | | % additional |
|---|---|---|---|---|---|---|
| Case | Blend | Carbon | added, by | % metal | % metal | smelted |
| # | # | source | weight | yield | (entrapped) | metal |
| A | 1 | none | 0 | 2.7% | 2.7% | |
| B | 1 | Coke 1 | 0.52 | 3.9% | 2.7% | 1.2% |
| C | 1 | Coke 2 | 0.52 | 3.7% | 2.7% | 1.0% |
| D | 2 | none | 0 | 2.9% | 2.9% | |
| E | 2 | Coke 1 | 0.52 | 3.6% | 2.9% | 0.9% |
| F | 2 | Coke 2 | 0.52 | 3.4% | 2.9% | 0.6% |
| G | 3 | biochar | 0.52 | 0.3% | 0.3% | |
| H | 3 | biochar | 0.81 | 2.11% | 0.3% | 2.08% |
| I | 4 | biochar | 1.6 | 0.55% | 0.3% | 0.52% |

In all cases, except A & D, reaction 2 (SiO₂ to Si metal) was slower (lower rate) than the Mn reaction, consistent with the literature. The lack of added carbon to the blend means that all reactions will be altered, limited to whatever can be activated by entrapped carbon in the slag, which is typically minor. In case G, there was not enough carbon to continue the reaction sequence.

Coke 2 reactions were faster than for Coke 1, which could relate to the purity of the coke, and/or the types of components in the remaining ash.

Biochar reactions were significantly slower, which is consistent with the literature. Biochar has less active carbon than the metallurgical cokes. However, the data shows that biochar effectively controls composition.

Roughly 3 times the amount of biochar was needed to have reaction rates comparable to that of Case B using metallurgical coke. It is assumed for the cases when no carbon is added that only entrapped metal is generated (melted). It is assumed for all cases that given enough time, all entrapped metal will be separated, and any additional yield is due to smelted metal from the reactions with carbon.

For case I, it is believed that the reaction needed to proceed for longer, and that additional metal is still trapped in the returned sample that was not able to be separated out.

Although overall metal yields were lower with the biochar source, it was capable of smelting metal.

The following set of data was obtained via predictive modeling of the disclosure. Predictive ideal modeling was used to determine the potential impact of metallurgical coke and biochar on the wool formulations.

Since the addition of carbon helps to drive the formation of SiMn metal from the melt, the remaining material (a slag) that is spun into fibers will have an altered chemistry. In general, the amount of MnO in the fiber will decrease, while other oxides will have a correspondingly higher weight fraction. Modeling was performed using compositional data for 1 of the metallurgical cokes used in the experiments, as well as for the biochar. The slag composition used was similar to that used in the experiments.

Modeling was done with increasing incremental changes in the carbon source, from 0.001 (0.1%) to 0.05 (5%). 100% coke, 100% biochar, 75% coke/25% biochar and 50-50 blends were also modeled. Impacts on the various oxides, viscosity and specific power were plotted. The metal yield (% SiMn generated) was also plotted.

In many cases, there is a plateau formed, which would occur when the maximum efficiency has been reached. Correlations were made to the linear regions of the plots. It is known that the model is an ideal case, and actual performance may be somewhat lower.

TABLE 4

| | | | % metal | % metal | % metal | Incremental | Increase in lbs |
|---|---|---|---|---|---|---|---|
| | | No | yield at | yield at | yield at | change in % | metal for 0.5% |
| % | % | carbon | 0.1% | 0.5% | 2.5% | yield at 0.5% | addition from 0 |
| Coke | Biochar | added | addition | addition | addition | increments | state for 1 ton slag |
| 0 | 0 | 1.59 | NA | NA | NA | NA | 31.8 (baseline) |
| 100 | 0 | 1.59 | 1.88 | 3.02 | 8.82 | 1.4 | 28.6 |
| 75 | 25 | 1.59 | 1.87 | 2.97 | 8.62 | 1.4 | 28.6 |
| 50 | 50 | 1.59 | 1.86 | 2.92 | 8.35 | 1.35 | 27 |
| 0 | 100 | 1.59 | 1.79 | 2.6 | 6.74 | 1 | 20 |

As the amount of effective carbon is increased, the metal yield increases. This is true for even small additions. For 1 ton of slag added, the number of pounds of SiMn metal generated is given. The amount of metal increases and then plateaus as carbon is added; not all metal can be extracted.

The amount of reacting carbon is greater in the coke than in the biochar, so as expected, the amount of SiMn generated increases more rapidly. The plateau is also reached more quickly.

SiMn metal is an important ingredient in certain ferro-alloys. By removing it from the wool in a secondary smelting process, this resource is being recovered, which is more sustainable than smelting an additional 1.8% from slags or ores.

A key operating viscosity of many fiberizing operations occurs in the range of 1400-1500° C. The addition of coke can be used to increase viscosity. By adding 0.5% coke, the viscosity at the midpoint of this range, 1450° C., is increased from 9.95 cp to 10.84 cp; with biochar the increase is slightly smaller, to 10.56 cp. Viscosity control is key to controlling the fiberization process. Adding small amounts of carbon via coke or biochar will increase viscosity. If the viscosity is well in the desired process window, this will have little to no impact on fiberization. If the viscosity is too low, it may help to thicken the melt. As the amount of carbon is increased, the thickening impact will also increase. This is due largely to the change in formulation: increases in SiO₂, Al₂O₃ and decreases in MnO canall act to increase viscosity.

At 1450° C., increasing the amount of coke from 0.5% to 1% will increase viscosity from 10.84 to 11.72 cp. A similar increase in biochar will increase viscosity from 10.56 to 11.21 cp.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

What is claimed is:

1. A method of smelting to form an inorganic fiber, the method comprising:
a) introducing a silicomanganese slag and a smelting additive into a furnace, the smelting additive comprising biochar;
b) smelting the silicomanganese slag in the presence of the smelting additive into a silicomanganese metal and a smelting byproduct; and
c) flowing the smelting byproduct from the furnace from a first outlet to a fiber spinning apparatus; and
step d) processing the smelting byproduct by the fiber spinning apparatus to form the inorganic fiber.

2. The method according to claim 1, wherein the smelting additive further comprises coke.

3. The method according to claim 1, wherein the inorganic fiber has a diameter ranging from about 3 microns to about 12 microns.

4. The method according to claim 1, wherein the smelting of the silicomanganese slag in step b) occurs at a temperature ranging from about 1100° C. to about 1800° C.

5. The method according to claim 1, wherein the smelting is performed by applying power to the silicomanganese slag such that the silicomanganese slag is smelted by resistance heating.

6. The method according to claim 1, wherein the silicomanganese slag forms at least part of an electrical resistance that causes the resistance heating to occur.

7. The method according to claim 1, wherein the smelting byproduct comprises a first composition that includes silicon dioxide, aluminum oxide, manganese oxide, magnesium oxide, and calcium oxide.

8. A building panel comprising a first major exposed surface opposite a second major exposed surface, the building panel comprising
a body having an upper surface opposite a lower surface, the body comprising
the inorganic fiber comprising:
SiO2 in an amount ranging from about 35 wt. % to about 50 wt. % based on the total weight of the inorganic fiber;
Al2O3 in an amount ranging from about 2 wt. % to about 22 wt. % based on the total weight of the inorganic fiber;
MnO in an amount ranging from about 1.5 wt. % to about 11 wt. % based on the total weight of the inorganic fiber;
MgO in an amount ranging from about 4 wt. % to about 20 wt. % based on the total weight of the inorganic fiber; and
CaO in an amount ranging from about 15 wt. % to about 30 wt. % based on the total weight of the inorganic fiber;
a binder; and
a filler.

9. The building panel according to claim 8, wherein the building panel exhibits an NRC value of at least 0.50.

10. The building panel according to claim 9, wherein the building panel exhibits an NRC value ranging from about 0.60 to about 0.95.

11. The building panel according to claim 8, wherein the body has a porosity ranging from about 60% to about 98%.

12. The building panel according to claim 8, wherein the body has a density ranging from about 2 lb/ft³ to about 16 lb/ft³.

13. The building panel according to claim 8, wherein the binder is selected from one or more of a starch-based polymer, polyvinyl alcohol (PVOH), a latex, polysaccharide polymers, cellulosic polymers, protein solution polymers, an acrylic polymer, polymaleic anhydride, polyvinyl acetate, and epoxy resins.

14. The building panel according to claim 8, wherein the filler is selected from one or more of calcium carbonate, including limestone, aragonite, titanium dioxide, sand, barium sulfate, clay, mica, dolomite, silica, talc, perlite, polymers, gypsum, wollastonite, expanded-perlite, calcite, aluminum trihydrate, pigments, zinc oxide, and zinc sulfate.

15. A system for the product of inorganic fiber from silicomanganese slag, the system comprising
a power control device;
a furnace comprising
a chamber;
a first outlet in fluid communication with the chamber;
a second outlet in fluid communication with the chamber; and
at least two electrodes;
a fiber spinning apparatus in fluid communication with the first outlet of the collection zone;
wherein a silicomanganese metal and a smelting additive comprising biochar are present in the chamber and the power control device is configured to apply power to the silicomanganese metal and biochar through the at least two electrodes; and
wherein the fiber spinning apparatus is configured to spin a smelting byproduct formed from the silicomanganese metal and biochar.

16. The system according to claim 15, wherein the fiber spinning apparatus is an inorganic fiber spinning apparatus.

17. The system according to claim 15, wherein the first outlet is in fluid communication with the fiber spinning apparatus via a gravity feed.

18. The system according to claim 15, wherein the smelting additive is substantially free of coke.

19. The system according to claim 15, wherein the furnace comprises three or more electrodes.

20. The system according to claim 15, wherein the chamber is substantially free of an external source of carbon.
